(19) United States
(12) Patent Application Publication
(10) Pub. No.: US 2004/0133674 A1
(43) Pub. Date: Jul. 8, 2004

(54) Remote management system, electronic apparatus, control method, and program that reduce communication costs in occurrence of abnormality

(76) Inventor: Katsuhiko Sasaki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/667,334

(22) Filed: Sep. 23, 2003

(30) Foreign Application Priority Data
Sep. 24, 2002 (JP) 2002-276524
Jul. 8, 2003 (JP) 2003-193878

(51) Int. Cl. G06F 15/177; G06F 9/445

(52) U.S. Cl. 709/224; 713/2

(57) ABSTRACT

An electronic apparatus includes an abnormality detector for detecting an abnormality when the abnormality occurs. An abnormality type determination part determines the type of the abnormality detected by the abnormality detector. The abnormality notification part informs an external apparatus of the abnormality when the type of the abnormality determined by the abnormality type determination part represents an abnormality that cannot be eliminated by a user of the electronic apparatus.

### BACKGROUND OF THE INVENTION

1. Field of the Invention

The present invention generally relates to electronic apparatuses having functions of communicating with external apparatuses, remote management systems constructed by the electronic apparatuses and management systems that remotely manage the electronic apparatuses via communication lines (networks), control methods applied at the time of occurrence of abnormality in the communication apparatuses (electronic apparatuses), and programs for realizing functions (functions relating to the present invention) necessary for computers that control the communication apparatuses.

2. Description of the Related Art

Conventionally, there has been proposed remote management systems in which a management apparatus (external apparatus) of a service center (management center) remotely manages apparatuses to be managed (hereinafter referred to as a “managed apparatus”) via a communication line (network), such as a public circuit and the Internet. Managed apparatuses include electronic apparatuses having communication functions (communication means) as well as image processing apparatuses having communication functions. Image processing apparatuses include a printer, a facsimile (FAX) apparatus, a digital copying apparatus, a scanner, a digital multi-functional apparatus and the like. Electronic apparatuses include network-connected home appliances, automatic vending machines, medical equipment, power supply equipment, air conditioning systems, measuring systems of gas, water, electricity etc., and the like.

Also, there has been proposed remote management systems in which the management apparatus remotely manages the managed apparatuses via an intermediate apparatus by connecting the intermediate apparatus, having communication functions that allow communication with the management apparatus, with the management apparatus, when the managed apparatuses are not provided with communication functions, or when the managed apparatuses are provided with communication functions but not functions for communicating with the management apparatus.

Here, assuming that the managed apparatus is an image forming apparatus, a description will be given of the image forming apparatus.

Typical image forming apparatuses form images on recording media, such as plain paper (sheet), by using a well-known electrostatic process (electrophotography processing). However, troubles (abnormality) occur at high rates in a mechanism performing such an electrostatic process. In addition, a maintenance service system is established since regular overhauls for maintaining performance are required.

In order to make such maintenance satisfactory, there has already been developed a remote management system for an image forming apparatus (refer to Japanese Laid-Open Patent Application No. 2002-6693, for example). In the remote system, an intermediate apparatus (communication apparatus) is provided inside or outside the image forming apparatus, and the image forming apparatus is connected with a management system installed in a service center via a public circuit (telephone circuit) or the Internet. When an abnormality occurs in the image forming apparatus, the abnormality is detected by abnormality detection means formed by a sensor, for example, and the abnormality is reported to the management apparatus by the intermediate apparatus.

In the image forming apparatus of such remote management system, any abnormality is reported to the management system every time an abnormality occurs, irrespective of the type (kind) of abnormality. In other words, notification to the management system is performed even if the abnormality can be eliminated by rebooting (resetting) the image forming apparatus with a simple operation. For this reason, there is a disadvantage in that communication costs are increased. Additionally, since the image forming apparatus is interrupted during the occurrence of an abnormality, there also is a disadvantage in that availability is reduced.

### SUMMARY OF THE INVENTION

A general object of the present invention is to provide an improved and useful electronic apparatus, remote management system therefor, control method applied to the electronic apparatus at the time of occurrence of abnormality, and program for causing a computer to realize functions necessary for controlling the communication apparatus (electronic apparatus) in which one or more of the above-mentioned problems are eliminated.

Another and more specific object of the present invention is to reduce communication costs in occurrence of abnormality in an electronic apparatus such as an image forming apparatus.

Still another object of the present invention is to improve the availability factor of an electronic apparatus such as an image forming apparatus.

In order to achieve the above-mentioned objects, according to one aspect of the present invention, there is provided an electronic apparatus that includes:

an abnormality detector for detecting an abnormality when the abnormality occurs;

an abnormality type determination part for determining a type of the abnormality detected by the abnormality detector; and

an abnormality notification part for informing an external apparatus of the abnormality when the type of the abnormality determined by the abnormality type determination part represents an abnormality that cannot be eliminated by a user of the electronic apparatus.

In addition, according to another aspect of the present invention, there is provided a remote management system remotely managing a plurality of electronic apparatuses by a management apparatus via a communication line, including:

the plurality of electronic apparatuses; and

the management apparatus,

wherein each of the electronic apparatuses includes:

an abnormality detector for detecting an abnormality when the abnormality occurs in the electronic apparatuses;

an abnormality type determination part for determining a type of the-abnormality detected by said abnormality detector; and

an abnormality notification part for informing the management apparatus of the abnormality, together with identification information of one or more of the electronic apparatuses in which the abnormality occurs, when the type of the abnormality determined by said abnormality type determination part represents an abnormality that cannot be eliminated by a user of said one or more of the electronic apparatuses.

Also, according to another aspect of the present invention, there is provided a method of controlling an electronic apparatus, the method including the steps of:

detecting an abnormality when the abnormality occurs in the electronic apparatus;

determining a type of the detected abnormality; and

informing an external apparatus of the abnormality when the determined type of the abnormality represents an abnormality that can not be eliminated by a user of the electronic apparatus.

Further, according to another aspect of the present invention, there is provided a program for causing a computer to control an electronic apparatus, the program including the instructions of:

causing the computer to detect an abnormality when an abnormality occurs in the electronic apparatus;

causing the computer to determine a type of the detected abnormality; and

causing the computer to inform an external apparatus of the abnormality when the type of the abnormality is determined to represent an abnormality that cannot be eliminated by a user of the electronic apparatus.

In addition, according to another aspect of the present invention, there is provided a processor-readable medium storing the program as mentioned above.

Other objects, features and advantages of the present invention will become more apparent from the following detailed description when read in conjunction with the following drawings.

### BRIEF DESCRIPTION OF THE DRAWINGS

FIG. 1 is a conceptual diagram showing a configuration of a remote management system having electronic apparatuses according to the present invention as managed apparatuses;

FIGS. 2A and 2B are conceptual diagrams showing data transmission and reception models in the remote management system;

FIG. 3 is a conceptual diagram showing a configuration of an image forming apparatus remote management system having image forming apparatuses according to the present invention as managed apparatuses;

FIG. 4 is a block diagram showing a hardware configuration of the image forming apparatus 100 shown in FIG. 3;

FIG. 5 is a block diagram showing a software configuration of the image forming apparatus 100 shown in FIG. 3;

FIGS. 6A, 6B and 6C are schematic diagrams for explaining a ENGRDY signal and a PWRCTL signal in the image forming apparatus 100 shown in FIGS. 4 and 5;

FIG. 7 is a function block diagram showing a configuration of the NRS 305 shown in FIG. 5;

FIG. 8 is a block diagram showing a physical configuration of the intermediate apparatus 101 shown in FIG. 3;

FIG. 9 is a block diagram showing a schematic configuration of the management apparatus 102 shown in FIG. 3;

FIG. 10 is a schematic diagram showing a communication sequence in transmitting and receiving data in the image forming apparatus remote management system shown in FIG. 3;

FIG. 11 is a schematic diagram showing a communication sequence in transmitting data to the management apparatus 102 from the image forming apparatus shown in FIG. 3;

FIG. 12 is an explanatory diagram showing an example of a table of information that serves as a reference for determining a kind (type) of abnormality;

FIG. 13 is a schematic diagram showing a communication sequence in a case where an SC of a type A is issued in the engine unit of the image forming apparatus 100 shown in FIG. 3;

FIG. 14 is an explanatory diagram showing examples of a display screen image that is displayed on a character display unit of an operation panel when an SC is issued in the image forming apparatus 100 shown in FIG. 3;

FIG. 15,is an explanatory diagram showing an example of the format of a SOAP message for SC report in an HTTP message;

FIG. 16 is an explanatory diagram showing the structure of a main part (data) of the HTTP message;

FIG. 17 is a schematic diagram showing a communication sequence in a case where an abnormality of a type D occurs in the engine, unit of the image forming apparatus 100 shown in FIG. 3;

FIG. 18 is a flow chart showing a process performed by the NRS 305 shown in FIG. 7 when an SC is issued;

FIG. 19 is a schematic diagram showing another communication sequence in a case where an abnormality of the type D occurs in the engine unit of the image forming apparatus 100 shown in FIG. 3;

FIG. 20 is a flow chart showing another process performed by the NRS 305 shown in FIG. 7 when an SC is issued;

FIG. 21 is a flow chart showing an SC report result reception process performed by the NRS 305 shown in FIG. 7;

FIG. 22 is a flow chart showing a report timeout process performed by the NRS 305 shown in FIG. 7;

FIG. 23.is a schematic diagram showing a communication sequence in a case where the SCS 306 shown in FIG. 5 receives a report that an SC in the image forming apparatus is reset; and

FIG. 24 is a schematic diagram showing another communication sequence in the case where the SCS 306 shown in FIG. 5 receives the report that the SC in the image forming apparatus is reset.

### DETAILED DESCRIPTION OF THE PREFERRED EMBODIMENTS

A specific description will now be given of preferred embodiments of the present invention, by referring to the drawings.

First, a description will be given of an exemplary embodiment of a remote management system according to the present invention, which system manages an electronic apparatus as an apparatus to be managed (hereinafter referred to as a “managed apparatus”).

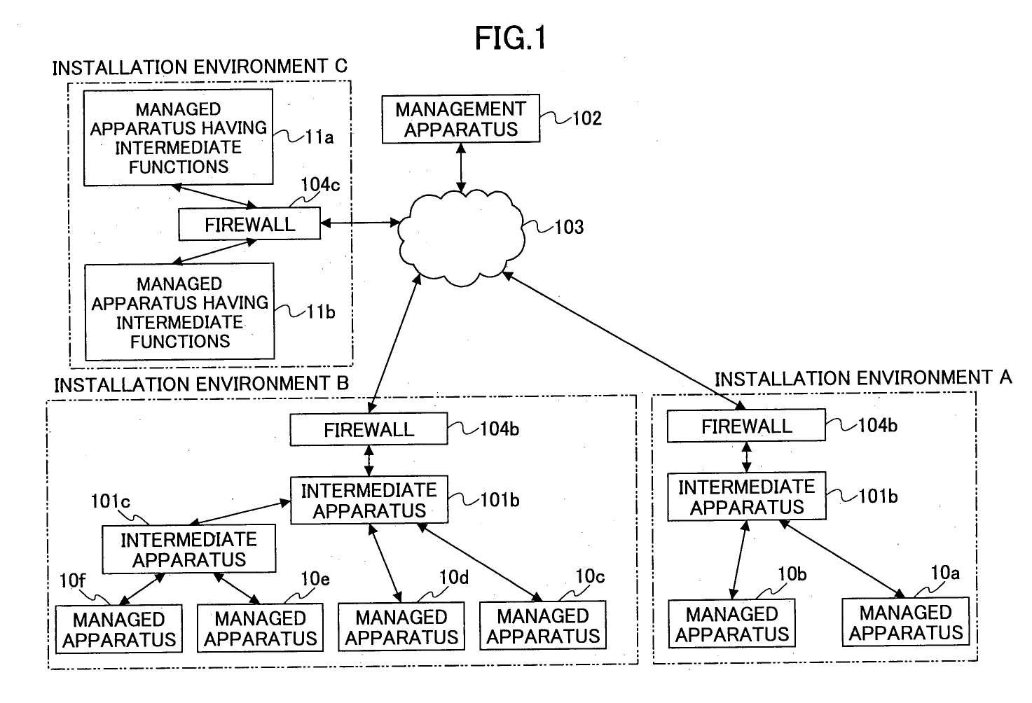

FIG. 1 is a conceptual diagram showing an example of the construction of the remote management system.

The remote management system manages managed apparatuses 10 (10a, 10b, 10c, 10d, 10e, and 10f), which are image forming apparatuses such as a printer, a FAX apparatus, a digital copying apparatus, a scanner, and a digital multi-functional apparatus, and communication apparatuses (electronic apparatuses) such as network-connected home appliances, automatic vending machines, medical equipment, power supply equipment, air conditioning systems, measuring systems of gas, water, electricity etc.. The remote management system includes intermediate apparatuses 101 (101a, 101b, and 101c) that serve as remote management intermediate apparatuses connected with the managed apparatuses 10 via a LAN (local area network) as external apparatuses (when seen from the managed apparatuses 10). Further, the remote management system includes a management apparatus 102 that functions as a server connected to the intermediate apparatuses 101 via, for example, the Internet 103 (an alternative network such as a public circuit may also be used). In this way, the management system 102 can remotely manage each of the managed apparatuses 10 via the intermediate apparatuses 101 in a centralized manner. The intermediate apparatuses 101 and the managed apparatuses 10 form various hierarchical structures in accordance with an environment in which they are used.

For example, an installation environment A shown in FIG. 1 is a simple structure where the intermediate apparatus 101a, which can establish direct connection with the management apparatus 102 by using, for example, HTTP (Hyper Text Transfer Protocol), is connected to the managed apparatuses 10a and 10b. On the other hand, in an installation environment B shown in FIG. 1, four managed apparatuses 10 (10c, 10d, 10e, and 10f) are installed. If only one intermediate apparatus 101 is installed, the processing load becomes heavy on such apparatus. For this reason, in the installation environment B, a hierarchical structure is formed where the intermediate apparatus 101b, which can establish direct connection with the management apparatus 102 by using HTTP, is connected to another intermediate apparatus 101c, and the intermediate apparatus 101c is further connected to the managed apparatuses 10e and 10f. In this case, information transmitted from the management apparatus 102 for remotely managing the managed apparatuses 10e and 10f arrives at the managed apparatus 10e or 10f via the intermediate apparatus 101b and the intermediate apparatus 101c which is a lower level node of the intermediate apparatus 101b.

In addition, as in an installation environment C, managed apparatuses 11a and 11b having intermediate functions (hereinafter also referred to as “managed apparatus” simply), which are managed apparatuses having the functions of an intermediate apparatus 101, may be connected to the management apparatus 102 via the Internet 103 without additionally using an intermediate apparatus.

It is also possible to further connect the managed apparatus that is equivalent to a managed apparatus 10 to a managed apparatus 11 having intermediate functions, though illustration thereof is omitted.

Further, it should be noted that firewalls 104 (104a, 104b and 104c) are installed in the respective environments A, B and C in consideration of security. The firewalls 104 are formed of proxy servers, for example.

In addition, it is also possible to connect a terminal unit, such as a personal computer, and an electronic apparatus (external apparatus) to each of the managed apparatuses 10 and 11 via a LAN, for example.

In such a remote management system, the intermediate apparatuses 101 install an application program for controlling and managing the managed apparatuses 10 that are connected with the intermediate apparatuses 101.

The management apparatus 102 installs an application program for controlling and managing each of the intermediate apparatuses 101 and further for controlling and managing the managed apparatuses 10 via the intermediate apparatuses 101. Each of the nodes in the remote management system, including the managed apparatuses 10, is capable of transmitting a “request” that is a request for processing with respect to a method of the application program installed in each node, and obtaining (receiving) a “response” that is the result of the requested processing by an RPC (remote procedure call)(described later).

That is, the intermediate apparatuses 101 or the managed apparatuses 10 connected thereto are capable of generating a request to the management apparatus 102, transmitting the request to the management apparatus 102, and obtaining the response to the request. Similarly, the management apparatus 102 is capable of generating a request and transmitting the same to the intermediate apparatuses 101, and obtaining the response to the request. This request includes a request for causing the intermediate apparatuses 101 to transmit various requests to the managed apparatuses 10 and obtaining responses from the managed apparatuses 10 via the intermediate apparatuses 101.

Further, in order to achieve an RPC (remote procedure call), well known protocols (communication protocols), techniques, specifications and the like may be used, such as SOAP (Simple Object Access Protocol), HTTP, FTP (File Transfer Protocol), COM (Component Object Model), and/or CORBA (Common Object Request Broker Architecture).

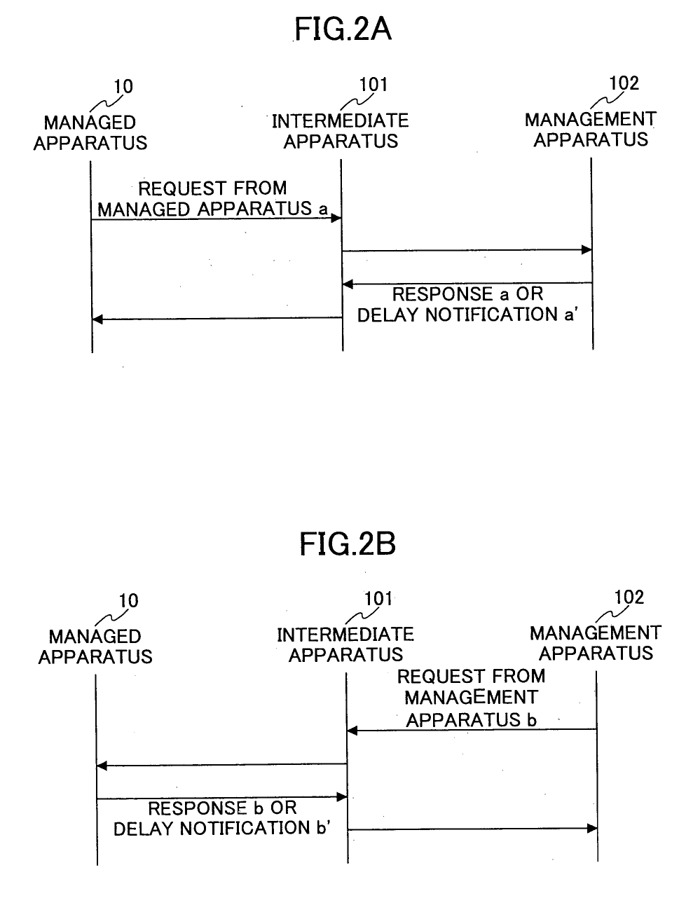

FIGS. 2A and 2B are conceptual diagrams of data transmission and reception models of the above-mentioned transmission and reception.

FIG. 2A shows a case where a request to the management apparatus 102 is generated at one of the managed apparatuses 10. The model in this case is as follows: the managed apparatus 10 generates a “request from the managed apparatus a”, and the management apparatus 102, receiving the request via the intermediate apparatus 101, returns a “response a” to the request. The present invention also contemplates the case where the number of intermediate apparatuses 101 shown in FIG. 2A is two or more (the installation environment B shown in FIG. 1). It should be noted that FIG. 2A shows the case where a “response delay notification a” is returned in addition to the “response a”. This is because the management apparatus 102 is configured such that, when it is determined that the response to the request cannot be returned immediately in response to reception of the “request from the managed apparatus” via the intermediate apparatus 101, the response delay notification is transmitted and connection is temporarily disconnected. The response to the request is then given later in a subsequent next connection.

FIG. 2B shows a case where a request to the managed apparatus 10 is generated by the management apparatus 102. The model in this case is as follows: the management apparatus 102 generates a “request from the management apparatus b”, and the managed apparatus 10 which receives this request via the intermediate apparatus 101 returns a “response b” to the request. In addition, similar to the case of FIG. 2A, in the case of FIG. 2B, a “response delay notification b′” is returned when the response cannot be returned immediately.

Next, a brief description will be given of an exemplary embodiment of the management apparatus 102 shown in FIG. 1. The management apparatus 102 is constructed of a control unit formed by a CPU, a ROM, a RAM and the like, a database, a modem, a proxy server, and the like. A detailed description of the construction will be given later.

Additionally, a brief description will be given of an exemplary embodiment of the intermediate apparatus 101 shown in FIG. 1. The intermediate apparatus 101 is constructed of a CPU, a ROM, a RAM, a nonvolatile memory, a network interface card (hereinafter referred to as a “NIC”), and the like. A detailed description of the construction will be given later.

Further, regarding the managed apparatus 11 having intermediate functions, the above-mentioned units may be simply added to the managed apparatus 10 so as to realize the functions of the intermediate apparatus 101. However, it is also possible to realize the functions of the intermediate apparatus 101 by using hardware resources provided to the managed apparatus 10, such as a CPU, a ROM, a RAM and the like, and causing the CPU to carry out an appropriate application or a program module.

Next, a description will be given of an image forming apparatus management system according to the present invention, which system is a remote management system having an image forming apparatus (electronic apparatus) as the managed apparatus. Such image forming apparatus is a more specific example of the remote management system shown in FIG. 1.

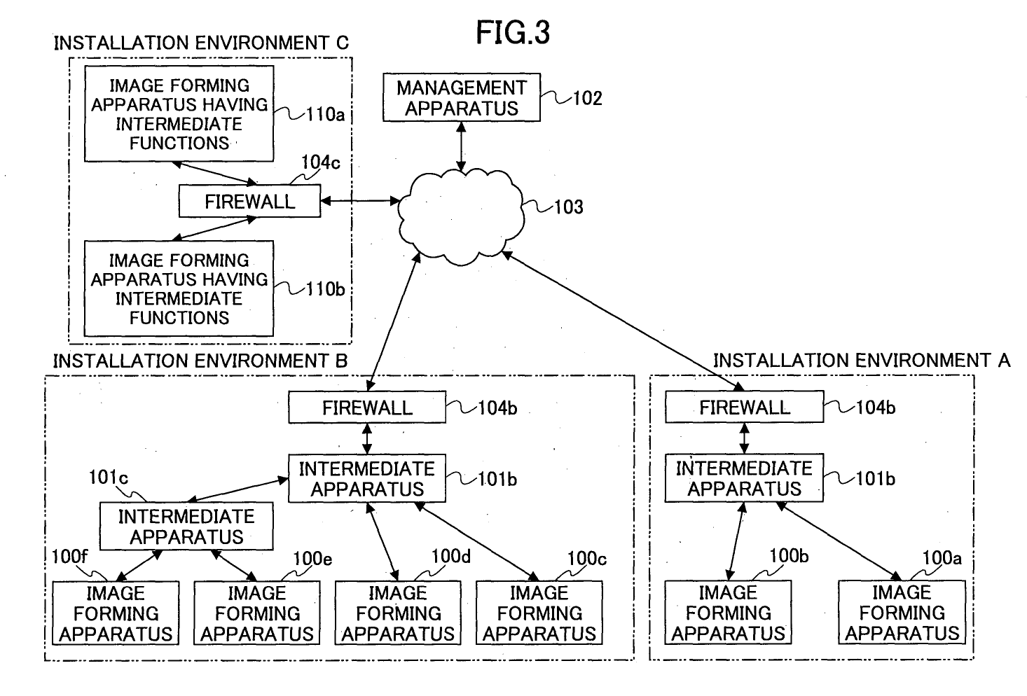

FIG. 3 is a conceptual diagram showing an exemplary construction of the image forming apparatus management system. A description of the structure of the system will be omitted to the extent that FIG. 3 differs from FIG. 1 in that the managed apparatuses 10 are changed to image forming apparatuses 100 and the managed apparatuses 11 with intermediate functions are changed to image forming apparatuses 110 having intermediate functions (hereinafter also referred to as “image forming apparatuses”).

The image forming apparatuses 100 are digital multi-functional apparatuses having functions of, for example, a copying machine, facsimile apparatus, scanner, and the like and functions for communicating with an external apparatus. The image forming apparatuses 100 install an application program for providing services relating to the above-mentioned functions. In addition, the image forming apparatuses 110 having intermediate functions are the image forming apparatuses 100 having the functions of the intermediate apparatuses 101.

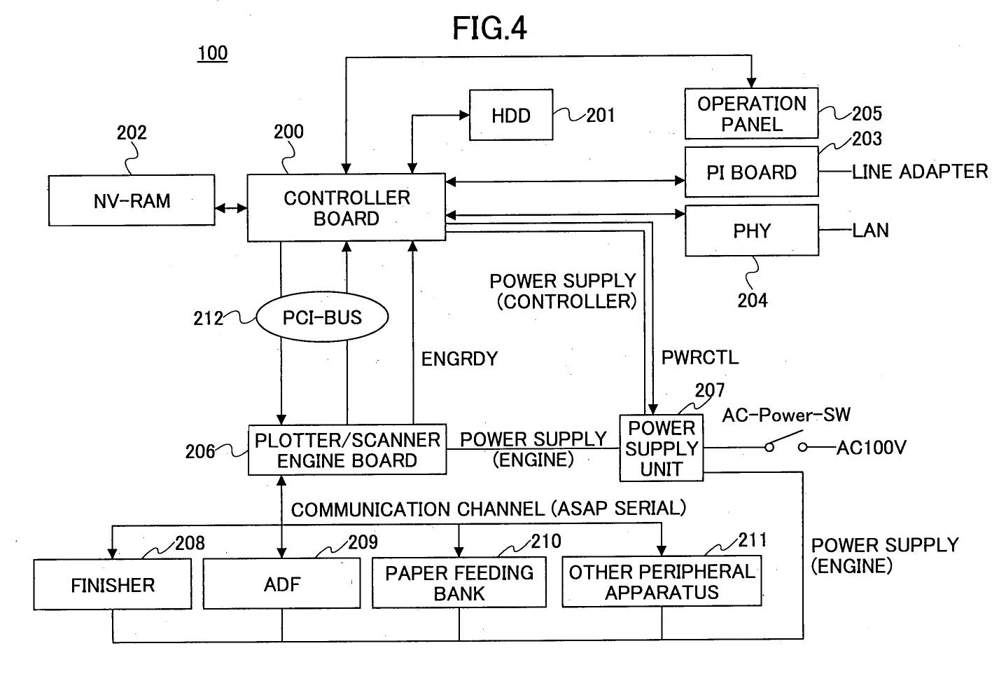

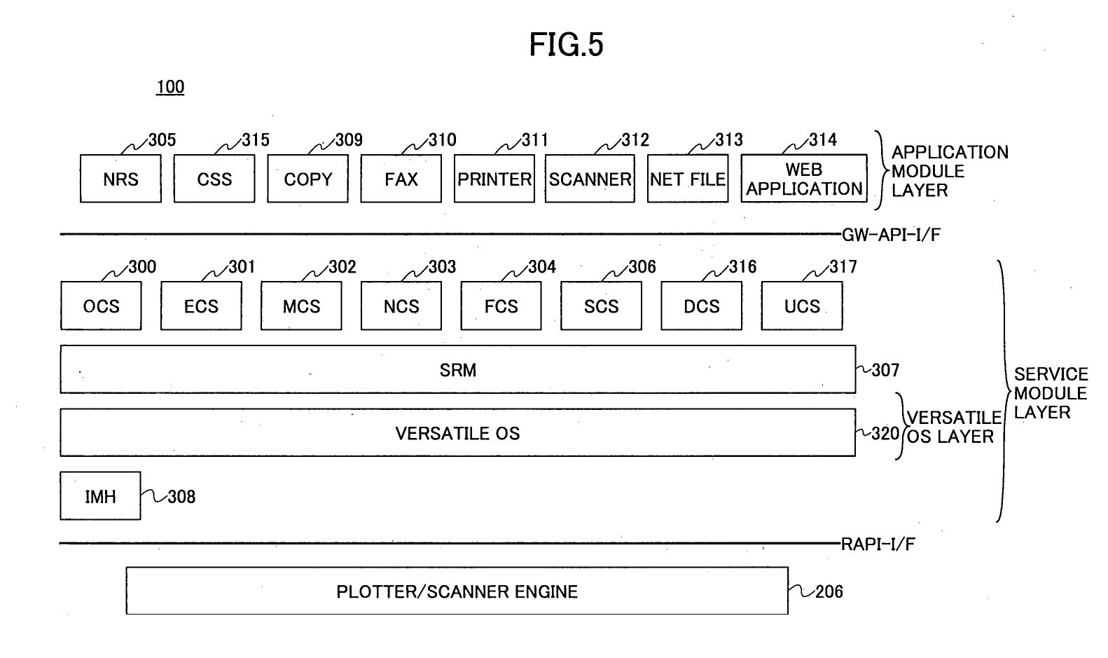

Referring to FIG. 4, a description will be given of an exemplary embodiment of the image forming apparatus 100.

FIG. 4 is a block diagram showing an example of the physical construction of the image forming apparatus 100. As shown in FIG. 4, the image forming apparatus 100 includes a controller board 200, a HDD (hard disk drive) 201, a NV-RAM (nonvolatile RAM) 202, a PI (personal interface) board 203, a PHY (physical media interface) 204, an operation panel 205, a plotter/scanner engine board 206, a power supply unit 207, a finisher 208, an ADF (automatic document feeder) 209, a paper feeding bank 210, and other peripheral apparatus 211. Each of these units is a hardware resource of the image forming apparatus 100.

The controller board 200 corresponds to control means. The controller 200 includes a CPU (hereinafter also referred to as a “controller CPU”), a ROM, a RAM and the like, and controls each function via a PCI-BUS. (Peripheral Components Interconnect-Bus) 212.

The RAM provided in the controller board 200 is volatile storing means that store and save information when power is supplied from the power supply unit 207.

The HDD 201 is nonvolatile storing means (a recording medium) that store and save information (data) irrespective of supply from the power supply unit 207.

The NV-RAM 202 is nonvolatile storing means and may be realized by using nonvolatile memory, such as EEPROM, flash memory, and nonvolatile RAM on which RAM and a backup circuit using a battery are integrated.

The PI board 203 and the PHY 204 correspond to communication means and are for external communication. For example, a communication board or the like corresponds to the PI board 203 and the PHY 204.

The PI board 203 includes an interface conforming to the RS485 standard and is connected to a public circuit via a line adapter. Examples of the public circuit are fixed telephone lines such as an analog circuit, an ADSL circuit, a digital circuit (ISDN circuit), and a circuit using optical fiber, and wireless phone lines such as mobile phone lines and PHS lines.

The PHY 204 is an interface for communicating with another electronic apparatus or a terminal unit such as a personal computer via a LAN.

The operation panel 205 is operation means including an operation part having various operation keys (also referred to as operation switches or operation buttons) and a display part having a character display part such as an LCD or a CRT.

An ENGRDY in FIG. 4 is a signal line for informing the controller board 200 that various initial settings of an engine unit (plotter/scanner engine board 206 in FIG. 4) are completed and that transmission of a command to and a reception of a command from the controller board 200 are ready. In addition, a PWRCTL is a signal line for controlling power supply to the engine unit by the controller board 200. The operations of the above-mentioned signal lines will be described later.

Next, referring to FIG. 5, a description will be given of an exemplary embodiment of a software configuration of the image forming apparatus 100.

FIG. 5 is a block diagram showing an example of the software configuration of the image forming apparatus 100.

The software configuration of the image forming apparatus 100 is formed by an application module layer, a service module layer, and a versatile OS layer.

Programs forming the software are stored in the HDD 201 or the RAM on the controller board 200, read out according to need, and carried out by the controller CPU, which CPU is on the controller board 200. Also, the programs may be stored in a recording medium, such as an optical disk (for example, a CD-ROM, a CD-R, a DVD-R, and a DVD-ROM), a magneto optical disk (for example, an MO), a flexible disk, and the like, and read out and carried out by the controller CPU as mentioned above. The controller CPU can realize various functions (abnormality detection means, abnormality notification means, abnormality type determination means, use request reception means, abnormality display means, abnormality history writing means, abnormality counting means, abnormality counting control means, reset means, formed image counting means, and the like) according to the present invention by executing the programs according to need.

The software in the application module layer is formed by programs that cause the controller CPU to function as a plurality of application control means (process execution means) that realize predetermined functions by operating the hardware resources. The software in the service module layer is formed by programs that cause the controller CPU to function as a service control means (process execution means). The service control means lie between the hardware resources and each of the application control means, and perform reception of an operation request from the plurality of application control means to the hardware resources, adjust the operation request, and control execution of an operation based on the operation request.

Among the above-mentioned functions, those functions relating to communication with the management apparatus 102 (for example, the functions performed as the abnormality notification means) are realized differently between the image forming apparatuses 100 and the image forming apparatuses 110. That is, in the case of the image forming apparatuses 110, the image forming apparatuses 110 are provided with the functions of the intermediate apparatuses. 101. Thus, it is possible to for the image forming apparatuses 110 to realize the functions relating to communication with the management apparatus 102 by executing the corresponding program by the controller CPU. On the other hand, in the case of the image forming apparatuses 100, it is possible to realize the functions relating to communication with the management apparatus 102 by executing the corresponding program by the controller CPU and by using the intermediate apparatuses 101.

Additionally, the image forming apparatus 100 is provided with a sensor in the engine unit, which includes a scanner engine and a plotter engine (image formation means). The sensor is for detecting an event such as abnormality.

The service module layer includes an operation control service (OCS) 300, an engine control service (ECS) 301, a memory control service (MCS) 302, a network control service (NCS) 303, a FAX control service (FCS) 304, a system control service (SCS) 306, a system resource manager (SRM) 307, an image memory handler (IMH) 308, a delivery control service (DCS) 316, and a user control service (UCS) 317. Also, the application module layer includes an NRS (new remote service) application (hereinafter simply referred to as “NRS”) 305, a CSS (customer support system) application (hereinafter simply referred to as “CSS”) 315, a copy application 309, a FAX application 310, a printer application 311, a scanner application 312, a Net File application 313, and a web application 314. Further, the versatile OS layer installs a versatile OS 320.

A more detailed description of the above-mentioned modules and applications will be given below.

The OCS 300 is a module for controlling the operation panel 205.

The ECS 301 is a module for controlling the engine unit such as the hardware resources.

The MCS 302 is a module for performing memory control. The MCS 302 obtains and releases image memory, and uses the HDD 201, for example.

The NCS 303 is a module for performing an intermediate process between a network and each application program in the application module layer.

The FCS 304 is a module for performing facsimile transmission and reception, facsimile reading, facsimile reception and printing, and the like.

The SCS 306 is a module for performing activation management and termination management of each application program in the application module layer in accordance with the contents of a command.

The SRM 307 is a module for performing system control and resource management.

The IMH 308 is a module for managing memory which temporarily stores image data.

The DCS 316 is a module for transmitting and receiving an image file or the like stored (to be stored) in the HDD 201 or the memory on the controller board 200 by using SMTP (Simple Mail Transfer Protocol) or FTP (File Transfer Protocol).

The UCS 317 is a module for managing user information, such as destination information and address information, registered by a user of the apparatus (user).

The NRS 305 is an application program that organizes functions relating to remote management (for example, functions relating to communication with the management apparatus 102) via a network, such as performing data exchange in transmitting and receiving data via the network.

The CSS 315 is an application program that organizes functions relating to remote management (for example, functions relating to communication with the management apparatus 102) via a public line, such as performing data exchange in transmitting and receiving data via the public line.

The copy application 309 is an application program for realizing copy service.

The FAX application 310 is an application program for realizing FAX service.

The printer application 311 is an application program for realizing printer service.

The scanner application 312 is an application program for realizing scanner service.

The Net File application 313 is an application program for realizing Net File service.

The web application 314 is an application program for realizing web service.

The versatile OS 320 is an operating system such as UNIX (registered trademark). The versatile OS 320 manages processes for executing the programs in the service module layer and the application module layer. Here, use of UNIX provides advantages in that security because of open source is guaranteed and source code can be obtained easily, for example. In addition, there is also a pragmatic advantage in that royalties on the protocols are not required regarding network matters.

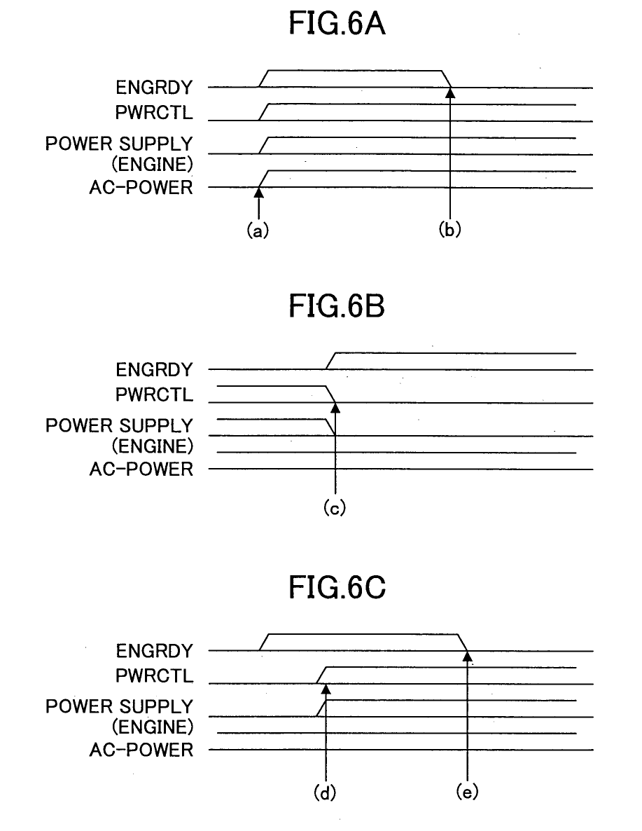

Referring to FIGS. 6A, 6B and 6C, a description will be given of the operations of the above-mentioned ENGRDY signal and PWRCTL signal.

FIG. 6A shows examples of the operations of the ENGRDY signal and PWRCTL signal at the start-up of the image forming apparatus 100. When a main power supply switch (AC-POWER-SW) is turned ON (indicated by (a) in FIG. 6A), and power is supplied to the power supply unit (main power supply) 207 from a power supply part of an AC 100V (AC power is ON), the power supply unit 207 takes an ON-state, supply from the power supply unit 207 to the entire apparatus including the controller board 200 is started, and simultaneously the ENGRDY signal becomes HIGH. In this state, communication with the engine unit cannot be performed, because initial setting of the engine unit is not completed. Communication with the engine unit becomes possible when initial setting of the engine unit is completed after a predetermined time duration and the ENGRDY signal becomes LOW (indicated by (b) in FIG. 6A, here, RAPI connection becomes possible on the engine side).

Next, FIG. 6B shows examples of the operations of the ENGRDY signal and PWRCTL signal when transit to an energy-saving mode is performed. Transition to the energy-saving mode is performed when the power supply unit 207 is in an ON-state (during power supply to the apparatus 100 from the power supply unit 207), when an instruction to stop feeding is given to the engine unit, which is a hard unit, by an operation conducted on a software power supply key (not shown) on the operation panel 205,. Thus, the PWRCTL signal is turned OFF by the controller board 200 (indicated by (c) in FIG. 6B). Simultaneously, power supply to the engine unit from the power supply unit 207 is stopped. Based on this, the ENGRDY signal becomes HIGH and transition to the energy-saving mode is performed.

Next, FIG. 6C shows the case where return from the energy-saving mode is performed.

FIG. 6C shows examples of the operations of the ENGRDY signal and PWRCTL signal in returning from the energy-saving mode to an ON-state. When returning from the energy-saving mode of FIG. 6B, an instruction to cancel stoppage of feeding is given to the engine unit by an operation conducted on the software power supply key, for example, and the PWRCTL signal is turned ON by the controller board 200 (indicated by (d) in FIG. 6C). Simultaneously, stoppage of power supply to the engine unit from the power supply unit 207 is canceled. However, as shown in FIG. 6A, the ENGRDY signal remains HIGH until the initial setting of the engine unit is attained. When the initial setting is attained, communication with the engine unit is enabled, and the ENGRDY signal becomes LOW (indicated by (e) in FIG. 6C, RAPI connection becomes possible on the engine side).

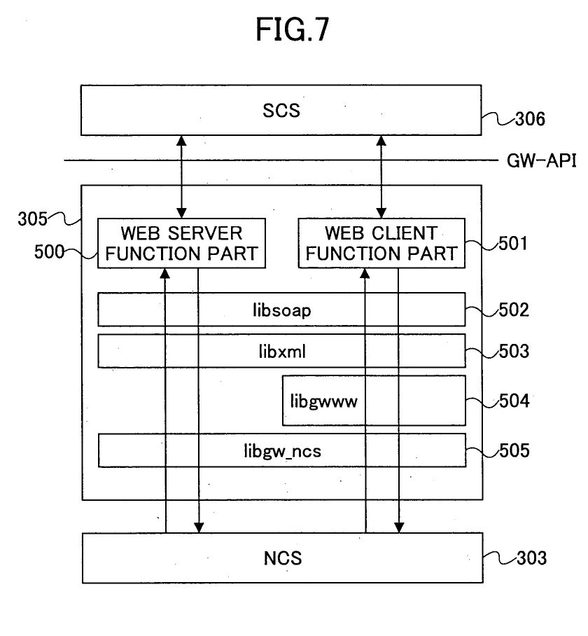

Next, referring to FIG. 7, a further description will be given of an exemplary embodiment of the NRS. 305, which is included in the software of the image forming apparatus 100 described above.

FIG. 7 is a function block diagram showing an example of the construction of the NRS 305. As shown in FIG. 7, the NRS 305 performs processes between the SCS 306 and the NCS 303. A web server function part 500 performs a response process relating to a request received from the outside. The request may be, for example, a SOAP request according to the SOAP (Simple Object Access Protocol) described in the XML (Extensible Markup Language) format, which is a structured language. The web client function part 501 performs a process of issuing a request to the outside. A libsoap 502 is a library that processes data in the SOAP format. A libxml 503 is a library that processes data described in the XML format. In addition, a libgwww 504 is a library that processes data in the HTTP format. A libgw_ncs 505 is a library that performs processes with respect to the NCS 303.

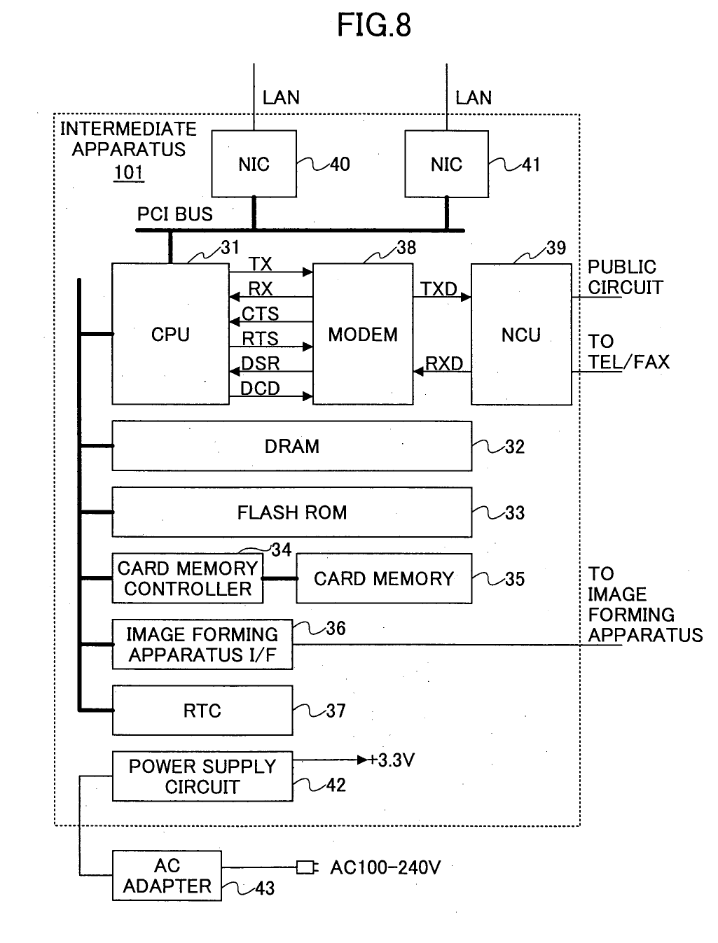

Next, referring to FIG. 8, a description will be given of an exemplary embodiment of the intermediate apparatus 101.

FIG. 8 is a block diagram showing an example of a physical construction of the intermediate apparatus 101.

The intermediate apparatus 101 includes a CPU 31, a DRAM 32, a flash ROM 33, a card memory controller 34, a card memory 35, an image forming apparatus I/F 36, a real time clock circuit (RTC) 37, a modem 38, an NCU (network control unit) 39, NICs 40 and 41, and a power supply circuit 42.

The CPU 31 is a central processing unit that controls the intermediate apparatus 101 based on various programs, including the OS (operating system), in the DRAM 32. For example, the CPU 31 controls the image forming apparatus 100 connected to the intermediate apparatus 101. Also, the CPU 31 controls transmission and reception of various data (or signals) with respect to the management apparatus 102 via a public circuit or the Internet by using the NCU 39 or the NICs 40 and 41. In addition, the CPU 31 makes a call to the management apparatus 102 via, for example, a public circuit by using data from the image forming apparatus 100. Further, the CPU 31 performs switching control (including control of circuit switching timing) of whether to connect to the image forming apparatus 100 or a telephone set (TEL) or a facsimile apparatus (FAX) which are an external communication equipment.

The DRAM 32 is main memory used as program memory storing the various programs including the OS, or as work memory used when the CPU 31 performs data processing, for example. In addition, SRAM may be used instead of the DRAM 32.

The flash ROM 33 is nonvolatile memory (nonvolatile storing means) used as program memory for storing a boot program, or as a database (DB) for storing transmission data from the management apparatus 102 to an image forming apparatus 100 (10a, 100b, 100c, . . . , 100f) and vice versa, circuit parameters (circuit information) including secret parameters (secret information), and the like. The flash ROM 33 maintains storing contents even if the power is turned OFF. Also, other nonvolatile memory such as EEPROM may be used instead of the flash ROM 33.

The card memory controller 34 controls reading and writing of various data with respect to the card memory 35.

The card memory 35 is a recording medium (nonvolatile storing means) such as SD memory. The card memory 35 records various programs such as an OS, a driver, and an application. The programs may be stored in the flash ROM 33. In addition, an HDD may be provided and may store the programs.

The image forming apparatus I/F 36 is image forming apparatus connection means connecting an image forming apparatus (not specifically shown in FIG. 8) that is a target of remote management.

The real time clock circuit (RTC) 37 generates time information. The CPU 31 is capable of recognizing the current time by reading the time information.

The modem 38 is modulation/demodulation means, and modulates data into a form that allows transmission over a public circuit, when the data are transmitted to the management apparatus 102 via the public circuit. Also, the modem 38 demodulates data when receiving modulated data that are transmitted from the management apparatus 102.

The NCU 39 controls communication (transmission and reception of data) with various types of external apparatuses, including the management apparatus 102, or external communication equipment (telephone set or facsimile apparatus) via a public circuit. Accordingly, it is possible to realize the functions of external communication equipment connection means.

The NICs 40 and 41 each control communication with various types of external apparatuses (electronic apparatuses), including each image forming apparatus 100 that is a target of remote management on a LAN (or other network), a firewall 104, and a terminal for management using a personal computer (not shown) or the like. Also, the NICs 40 and 41 each control communication with various external apparatuses, including the management apparatus 102, via the firewall 104 and the Internet 103. Accordingly, it is possible to realize the functions of the image forming apparatus connection means.

The power supply circuit 42 converts AC power (commercial power) from an AC adapter 43 to DC power and supplies the power to each of the above-mentioned units in the intermediate apparatus 101.

The modem 38 and the CPU 31 are connected by data lines including a transmission data line (TX) and a reception data line. (RX), and signal lines including a clear to send signal (CTS), a request to send signal line (RTS), a data set ready signal line (DSR), and a data carrier detect signal line (DCD). The modem 38 is controlled in accordance with the request to send signal (RTS) and data carrier detect signal (DCD) from the CPU 31.

In addition, the NCU 39 and the modem 38 are connected by signal lines including a reception data line (RXD) and a transmission data line (TXD). The reception data (RXD) are analog signals modulated by a modem of the management apparatus 102. The transmission data (TXD) are analog signals modulated by the modem 38.

Further, when the power is turned ON (the power is fed from the power supply circuit 42), according to the boot program in the flash ROM 33, the CPU 31 reads the various programs, including the OS, in the card memory 35 by controlling the card memory controller 34, and installs the programs in the program memory of the DRAM 32. The CPU 31 is operated in accordance with the various programs (the various programs are selectively carried out according to need), and various functions are realized by selectively using the real time clock circuit 37, the modem 38, the NCU (network control unit) 39, and the NICs 40 and 41 according to need.

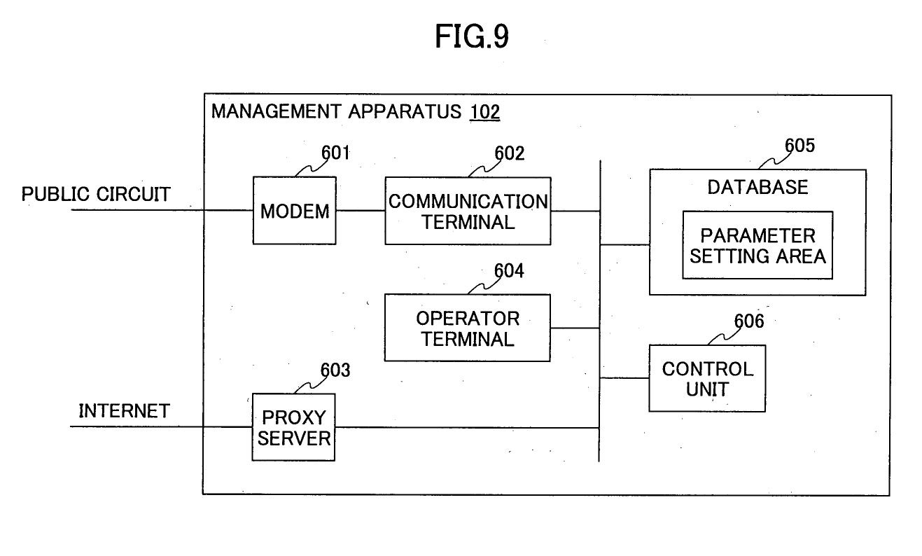

Next, referring to FIG. 9, a description will be given of an exemplary embodiment of the management apparatus 102.

FIG. 9 is a block diagram showing an example of the physical construction of the management apparatus 102.

The management apparatus 102 includes a modem 601, a communication terminal 602, a proxy server 603, an operator terminal 604, a database 605, a control unit 606, and the like.

The modem 601 communicates with the intermediate apparatus 101 or the image forming apparatus 110 on the user's end (for example, on the end of a user using the image forming apparatus) via a public line, for example. The modem 601 modulates and demodulates transmission data and reception data, respectively. The modem 601 serves as communication means together with the communication terminal 602, which will be described later.

The communication terminal 602 controls communication carried out by the modem 601.

The proxy server 603 performs security management and communication with the intermediate apparatus 101 or the image forming apparatus 110 on the user's end via the Internet, for example. The proxy server 603 also serves as the communication means.

The operator terminal 604 accepts inputs of various data via an input part such as a keyboard or a pointing apparatus (mouse, for example) when an operation is conducted thereon by the user.

The database 605 is in a storage unit such as a hard disk of a server (not shown). The database 605 stores data received from the intermediate apparatus 101 and the image forming apparatus 110 on the each user's end, data input from the operation terminal 604, and various data such as programs. The database 605 includes a parameter storing (setting) area in a predetermined area and stores various parameters including circuit parameters.

The control unit 606 is provided with a micro computer formed by a CPU, ROM, RAM and the like. The control unit 606 controls the management apparatus 102. It is possible to realize various functions by operating the CPU in accordance with the programs (carrying out the programs according to need) and selectively using the modem 601, the communication terminal 602, or the proxy server 603.

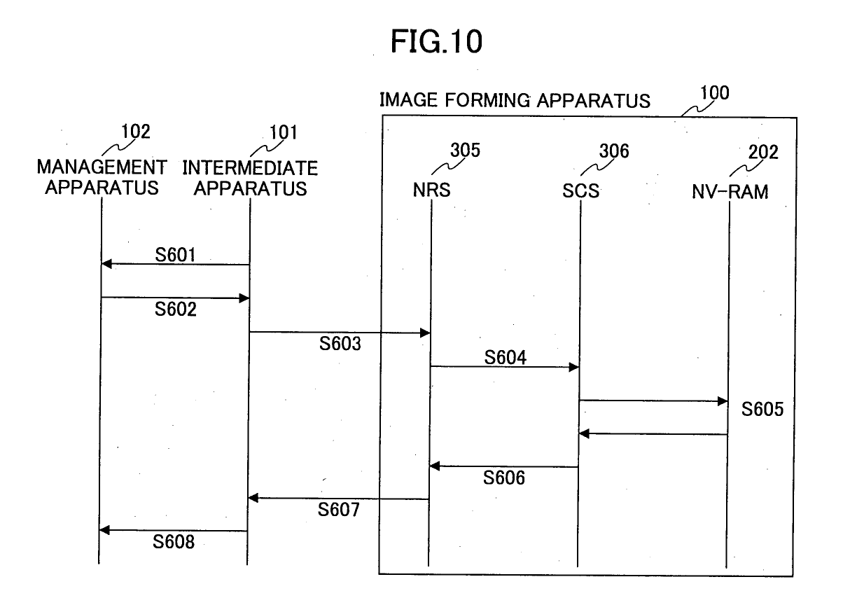

Referring to FIG. 10, based on the above-mentioned construction, a description will be given of an exemplary embodiment of a communication sequence in transmitting and receiving data in the image forming apparatus management system shown in FIG. 3. Processes of the SCS 306 and the NRS 305, which are explained below, are actually carried out by operations of the controller CPU in accordance with the programs. However, for convenience of explanation, it is assumed that the processes are carried out by the programs.

FIG. 10 is a diagram showing an example of a communication sequence in transmitting and receiving data among the management apparatus 102, the intermediate apparatus 101, and the image forming apparatus 100.

In this example, first, in step S601, the intermediate apparatus 101 performs polling (inquiry as to whether or not there is a transmission request) on the management apparatus 102. In other words, the intermediate apparatus 101 generates, for example, an HTTP message including a SOAP message for polling to which an identifier representing self-identification information is added. Then, the intermediate apparatus 101 transmits the message to the management apparatus 102 via the Internet 103, for example.

When the management apparatus 102 receives the HTTP message from the intermediate apparatus 101, the management apparatus 102 generates an HTTP message including a SOAP message representing an accounting counter data obtaining request, and transmits the request to the intermediate apparatus 101 (the transmitting source of the received SOAP message) via the Internet 103 in step S602. On this occasion, the corresponding intermediate apparatus 101 is recognized based on the identifier added to the SOAP message in the received HTTP message.

When the intermediate apparatus 101 receives the HTTP message from the management apparatus 102, in step S603, the intermediate apparatus 101 generates a SOAP message representing the accounting counter data obtaining request based on the HTTP message, and transmits the request to the NRS 305 of the image forming apparatus 100 that is connected to the intermediate apparatus 101 via the LAN.

In step S604, the NRS 305 notifies the SCS 306 of the accounting counter data obtaining request described in the SOAP message that is received from the intermediate apparatus 101.

When the SCS 306 receives the notification of the accounting counter data obtaining request from the NRS 305, in step S605, the SCS 306 reads data of accounting counter stored in the NV-RAM 202. Then, in step S606, the SCS 306 transmits the read data (response data) of accounting counter to the NRS 305.

When the NRS 305 receives (obtains) the data of accounting counter from the SCS 306, in step S607, the NRS 305 generates a SOAP message for accounting counter, representing the contents of the data, (converts the received data into the XML format that is a structured language format), and transmits the message to the intermediate apparatus 101 via the LAN.

When the intermediate apparatus 101 receives the SOAP message for accounting counter from the NRS 305, in step S608, the intermediate apparatus 101 generates an HTTP message based on the SOAP message, and transmits the message to the management apparatus 102 via the Internet 103.

In this manner, transmission and reception of data are performed according to the above-mentioned communication sequence.

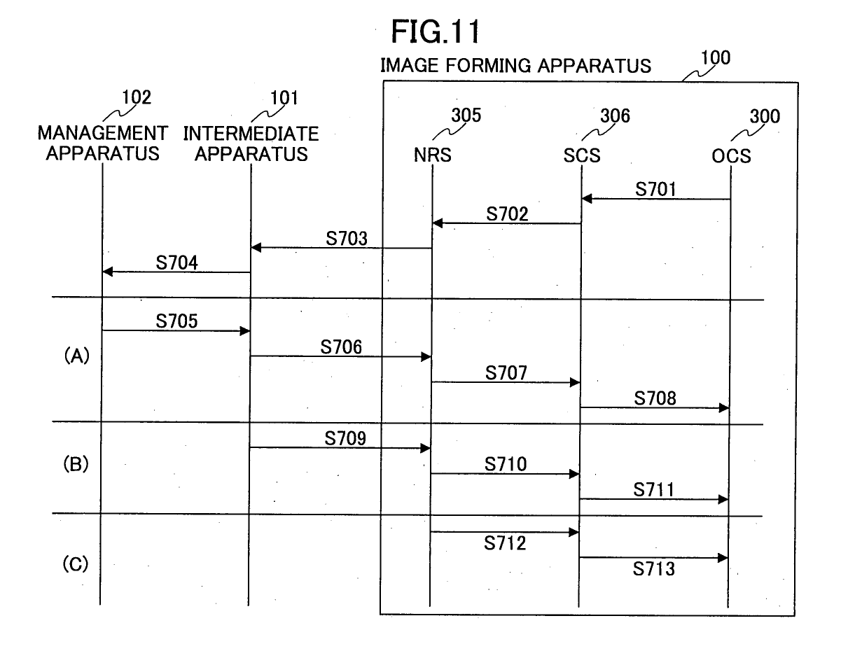

Next, referring to FIG. 11, a description will be given of an exemplary embodiment of a communication sequence in the case where, unlike the case shown in FIG. 10, data are transmitted to the management apparatus 102 from the image forming apparatus 100 via the intermediate apparatus 101.

FIG. 11 is a diagram showing an example of communication sequence in the case where data are transmitted from the image forming apparatus 100 to the management apparatus 102.

In this example, first, in step S701, the OCS 300 notifies the SCS 306 that a user call key (not shown) on the operation panel 205 is pressed down.

When the SCS 306 receives from the OCS 300 the notification that the user call key is pressed down, the SCS 306 notifies the NRS 305 of a user call request in step S702.

When the NRS 305 receives from the SCS 306 the notification of the user call request, the NRS 305 generates a SOAP message for user call, which is user call information informing of the user call, and transmits the message to the intermediate apparatus 101 via the LAN.

When the intermediate apparatus 101 receives from the NRS 305 the SOAP message for user call, the intermediate apparatus 101 adds an identifier representing self-identification information to the SOAP message, further generates an HTTP message based on the SOAP message, and makes a user call with respect to the management apparatus 102 via the Internet,103. That is, in step S704, the intermediate apparatus 101 reports, to the management apparatus 102 via the Internet 103, the HTTP message including the SOAP message for user call to which the self-identifier is added. Here, patterns after the process of step S704 will be explained by dividing the patterns into (A), (B), and (C).

First, in the pattern (A), the management apparatus 102 receives the HTTP message including the SOAP message for user call from the intermediate apparatus 101, which is on the user's end. When the reception ends normally, in step S705, the management apparatus 102 generates an HTTP message including a SOAP message representing the result of the call (success of the user call), and transmits the message to the intermediate apparatus 101, which is the reporting source, via the Internet 103. On the other hand,,when the reception does not end normally (that is, ends abnormally), the management apparatus 102 generates an HTTP message including a SOAP message representing the result of the call (failure of the user call), and transmits the message to the intermediate apparatus 101, which is the reporting source, via the Internet 103.

When the intermediate apparatus 101 receives, from the management apparatus 102, the HTTP message including the SOAP message representing the result of the call, in step S706, the intermediate apparatus 101 generates a SOAP message representing the result of the call based on the HTTP message, and transmits via the LAN the message to the NRS 305 of the image forming apparatus 100 whose user call key is pressed down.

When the NRS 305 receives, from the intermediate apparatus 101, in step S707, the SOAP message representing the result of the call, the NRS 305 interprets (determines) the result of the call represented by the SOAP message, and reports it to the SCS 306.

When the SCS 306 receives the result of the call, the SCS 306 transmits it to the OCS 300.

When the OCS 300 receives the result of the call from the SCS 306, in step S708, the OCS 300 displays a message representing the contents, that is, whether the user call is successful or a failure, on a character display unit of the operation panel 205.

In the pattern (B), when the intermediate apparatus 101 determines that there is no response from the management apparatus 102 after a specified time. (predetermined time that is set in advance) has elapsed, in step S709, the intermediate apparatus 101 generates a SOAP message representing the result (failure) of the call, and transmits the message to the NRS 305.

When the NRS 305 receives the SOAP message representing the result (failure) of the call, in step S710, the NRS 305 interprets the result (failure) of the call described in the SOAP message and reports it to the SCS 306.

When the SCS 306 receives the result of the call from the NRS 305, the SCS 306 transmits the result to the OCS 300.

When the OCS 300 receives the result of the call from the SCS 306, in step S711, the OCS 300 displays the contents, that is, the message representing the failure of the user call, on the character display unit of the operation panel 205.

In the pattern (C), when the NRS 305 determines that there is no response from the intermediate apparatus 101 after a specified time has elapsed, in step S712, the NRS 305 reports the result of the call, which represents the failure of the user call, to the SCS 306.

When the SCS 306 receives the result of the call from the NRS 305, the SCS 306 transmits it to the OCS 300.

When the OCS 300 receives the result of the call from the SCS 306, in step S713, the OCS 300 displays the contents, that is, the message representing the failure of the user call, on the character display unit of the operation panel 205.

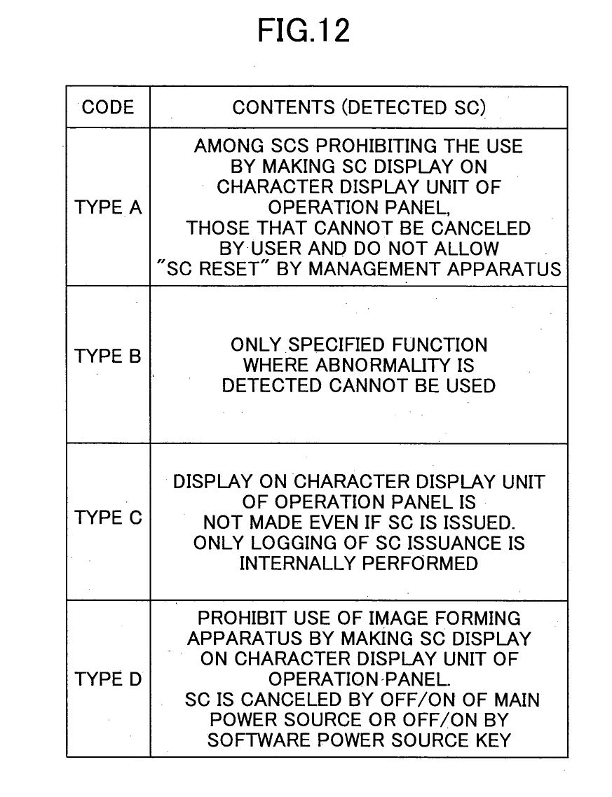

Here, in the image forming apparatus 100, the controller CPU, which controls each hardware resource such as the plotter engine and the operation panel 205, monitors the state of each hardware resource. When a predetermined event, for example, an abnormality, occurs in any of the hardware resources, the event is detected, and different processes are performed depending on the kinds of event detected. Information serving as a reference for determining the kind of event is required. FIG. 12 shows the data structure of a table showing examples of information (reference information) for determining a kind of abnormality. Here, “SC (service person call)” is equivalent to an “abnormality”. As shown in FIG. 12, the kind (type) of event is determined according to the detected SC. A description will now be given of exemplary kinds of events.

“Type A” represents an SC that cannot be solved (canceled) by a person using the apparatus (user) among SCs prohibiting the use of the apparatus by displaying the SC on the character display unit (display unit) of the operation panel 205. “Type A” includes an event that does not allow “SC reset” by the management apparatus 102, for example, an SC relating to a fixing system.

“Type B” represents an SC that does not allow the use of a specific (predetermined) function in which abnormality is detected. In normal use, an SC is not displayed on the character display unit of the operation panel 205. However, only when the specified function in which abnormality is detected is selected by a key operation conducted on the operation panel 205 (when a use request for the function in which abnormality is detected is received from the operation panel 205), the SC is displayed on the character display unit. An example of this is in a case where a duplex mode is selected when a-duplex unit is an abnormal condition.

“Type C” represents an SC that performs internal logging (history saving) of occurrence of SCs, without any display on the character display unit of the operation panel 205. For example, a case where communication becomes impossible corresponds to the “type C”.

“Type D” represents an SC that makes the SC display on the character display unit of the operation panel 205 so as to prohibit the use of the image forming apparatus (electronic apparatus), but can be solved by OFF/ON (an operation of temporarily turning OFF and then turning ON again) of the main power supply (power supply unit 207), or by an operation of the software power supply key or a reboot key. There is also a case where the SC is detected again after the main power supply is turned ON (feed of power supply) and the SC does not seem to be solved. For example, motor malfunction corresponds to the “type D”. The present invention contemplates that the reference information for the above-mentioned determination is stored in a predetermined storage area of the NV-RAM 202 (or the HDD 201). Further, events of units are treated as different events, such as an SC of the scanner engine and an SC of the plotter engine.

Next, a description will be given of an exemplary embodiment of the image forming apparatus 100 and the image forming apparatus management system, that is, the processes characterizing the present invention (control performed by the image forming apparatus 100 at the time of the occurrence of an abnormality). In addition, it should be noted that the image forming apparatus 110 also performs the processes characterizing the present invention. However, since the processes performed by the image forming apparatus 110 are similar to those performed by the image forming apparatus 100, a description thereof will be omitted.

As described above, the image forming apparatus 100 is provided with both the communication means corresponding to the public circuit and the communication means corresponding to Internet communication.

Also, the image forming apparatus 100 is configured to be able to serve as the target of remote management (remote service: RS) according to a customer support system method in which communication is made with the management apparatus 102 via the intermediate apparatus 101 and the public circuit. The image forming apparatus 100 is also configured to be able to serve as the target of remote management according to a new remote service method in which communication is made with the management apparatus 102 via the intermediate apparatus 101 and the Internet 103.

The image forming apparatus 110 is equipped with the functions of the intermediate apparatus 101. Accordingly, the image forming apparatus 110 is likewise configured to be able to serve as the target of the remote management according to the customer support system method in which communication is made with the management apparatus 102 via the public circuit. Similarly, the image forming apparatus 110 is also configured to be able to serve as the target of the remote management according to the new remote service method in which communication is made with the management apparatus 102 via the Internet 103.

The image forming apparatuses 100 and 110 are provided with the CSS 315 corresponding to the customer support system method and the NRS 305 corresponding to the new remote service method, as the programs for transmitting information representing the state of the engine unit, and for reporting to the management apparatus 102 event information that informs an event when an event causing reporting occurs in the hardware resources such as the engine unit.

For convenience of explanation, a description will be given of the processes characterizing the present invention in a case where the image forming apparatus 100 uses the NRS 305. It should be noted that the processes characterizing the present invention may also be performed by the image forming apparatus 100 using the CSS 315. In addition, the processes characterizing the present invention may also be performed by the image forming apparatus 110 using the NRS 305 or the CSS 315.

First, a description will be given of the case where an SC (abnormality) of the “type A” in FIG. 12 occurs in the engine unit (the scanner engine or the plotter engine) of the image forming apparatus 100.

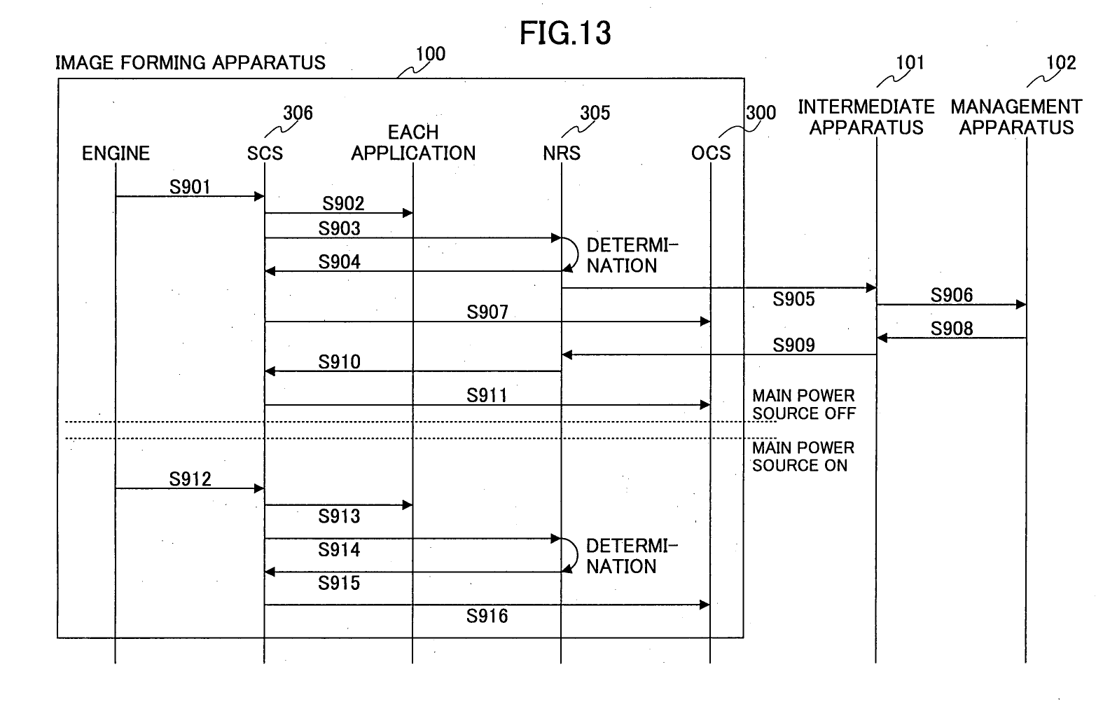

FIG. 13 is a diagram showing a communication sequence in the case where an SC of the “type A” occurs in the engine unit of the image forming apparatus 100. The processes performed by each application program (that is described below), the SCS 306, the NRS 305, and the OCS 300 are actually carried out by operations of the controller CPU in accordance with programs. However, for convenience of explanation, it is assumed that the processes are performed by the programs.

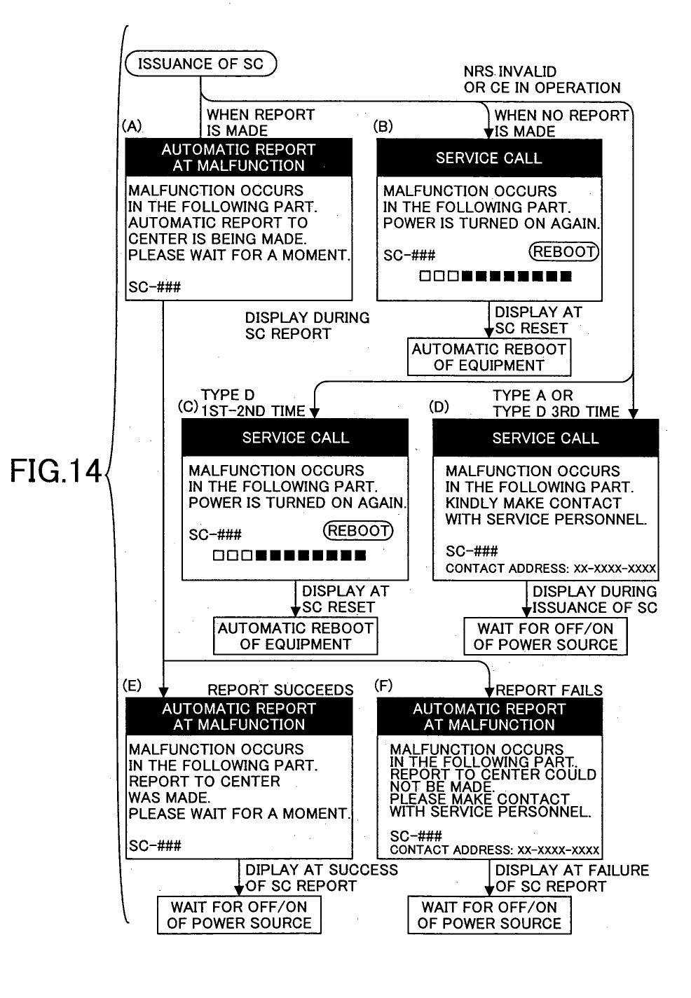

FIG. 14 is a diagram showing examples of display screen images that are displayed on the character display unit of the operation panel 205 at the time of occurrence of an SC of the image forming apparatus 100. These display screen images are stored as data in a predetermined storage area of the HDD 201 or the NV-RAM 202, for example.

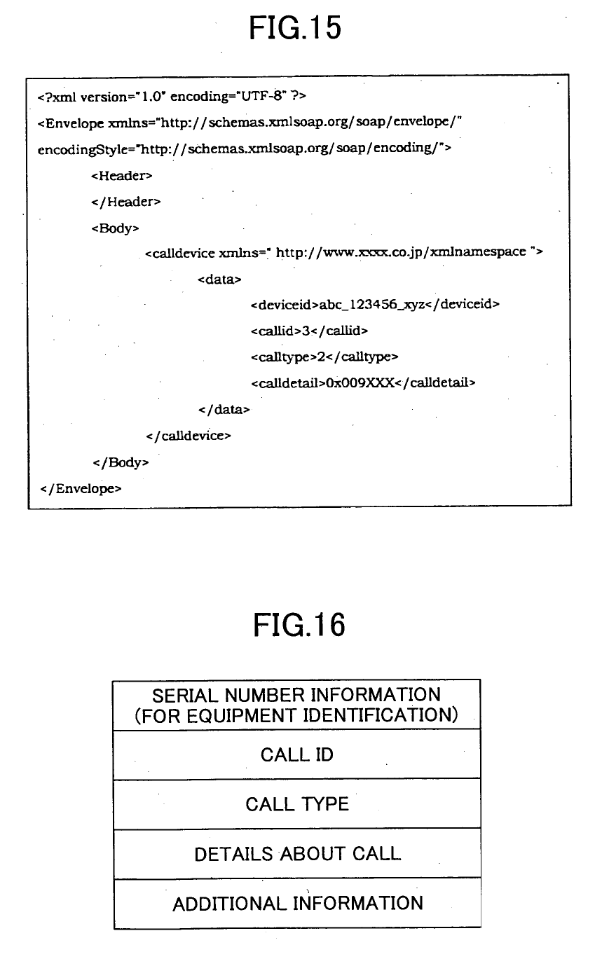

FIG. 15 is an explanatory diagram showing a format of a SOAP message for reporting an SC in an HTTP message. In addition, FIG. 16 is an explanatoty diagram showing the structure of a main part (data) of the HTTP message.

Referring again to the sequence diagram of FIG. 13, in the image forming apparatus 100, when an SC (abnormality) of the type A occurs in the engine unit, in step S901, the SC is detected by an engine CPU (that is, the CPU of the engine unit) while using a sensor, and the occurrence of the SC is reported to the SCS 306 of the controller board 200.

When the SCS 306 receives the report informing the occurrence of the SC from the engine CPU, the SCS 306 determines the type of the SC based on the reference information (reference data) shown in FIG. 12. In the exemplary embodiment, the type of SC that occurred this time is determined as a type A, which cannot be solved by the user of the image forming apparatus 100. Accordingly, the SCS 306 reports the occurrence of the SC to each application in step S902, and thereafter also reports the occurrence to the NRS 305 in step S903. On this occasion, serial number information representing the identification information of the image forming apparatus 100 is added to the data to be reported (report data).

When the NRS 305 receives the report of the occurrence of the SC of type A, the NRS 305 determines whether or not an SC report is required. At the-first time, the NRS 305 determines that a report is required. Thus, the NRS 305 reports to the SCS 306 starting of the SC report in step S904. Also, the NRS 305 generates a SOAP message (including the serial number information added to the report data of the SC) for the SC report (hereinafter referred to as “SOAP message for SC report) (converts the received report data of the SC into the XML format, which is a structured language format), and transmits the SOAP message to the intermediate apparatus 101 via the LAN in step S905.

When the SCS 306 receives the report of starting of the SC report, in step S907, the SCS 306 reports, to the OCS 300, a display request for displaying that the SC report is being made.

When the OCS 300 receives the display request for displaying that the SC report is being made from the SCS 306, the OCS 300 displays on the character display unit of the operation panel 205 a message screen as indicated by (A) in FIG. 14, which informs that the SC report is in operation. The screen displays information of the type of SC and the like.

When the intermediate apparatus 101 receives the SOAP message for SC report from the NRS 305, in step S906, the intermediate apparatus 101 adds to the SOAP message an intermediate apparatus identifier that is identification information of the intermediate apparatus 101. Also, the intermediate apparatus 101 generates an HTTP message based on the SOAP message and transmits a SC report with respect to the management apparatus 102 of the service center via the Internet 103. In other words, the intermediate apparatus 101 automatically reports (automatically transmits) to the management apparatus 102 of the service center via the Internet 103, the HTTP message including the SOAP message for SC report to which the intermediate apparatus identifier is added.

Referring to FIGS. 15 and 16, a brief description will now be given of exemplary embodiments of a format of a SOAP message (except the identifier of the intermediate apparatus 101) for SC report in the HTTP message.

As can be seen from FIGS. 15 and 16, the SOAP message for SC report includes: the serial number information representing the identification information of the image forming apparatus 100 in which the SC occurs; an arbitrary call ID representing the SC call (the SC report); a call type (the type of the SC); and information representing the detail of the call. It is also possible to add to the SOAP message for SC report, as additional information, information of a jam, an SC, status (condition), respective values of counters, and log (history information) of the image forming apparatus 100 in which the SC occurs.

The management apparatus 102 of the service center receives the HTTP message including the SOAP message for SC report that is reported from the intermediate apparatus 101 on any of the user's end. When the reception ends normally, in step S908, based on the serial number information and the intermediate apparatus identifier that are added to the SOAP message in the received HTTP message, the management apparatus 102 generates an HTTP message including a SOAP message representing success (result of report) of the SC report that is the report of the HTTP message. Also, the management apparatus 102 transmits the generated message to the intermediate apparatus 101 that is the reporting source (the intermediate apparatus 101 that transmits the HTTP message including the SOAP message for SC report) via the Internet 103.

In addition, the SOAP message in the received HTTP message is stored in a queue (the database 605) and is queued until a corresponding process is performed by a center operator.

Further, the contents of the SOAP message in the received HTTP message are displayed on a display unit of the operator terminal 604 to inform the center operator of the contents.

When the reception of the HTTP message including the SOAP message reported from the intermediate apparatus 101 of any of the user's end does not end normally (ends abnormally), an HTTP message including a SOAP message representing the failure (result of report) of the SC report that is the report of the HTTP message is generated, and the generated message is transmitted to the intermediate apparatus 101 that is the reporting source via the Internet 103 based on the identifier added to the SOAP message in the received HTTP message.

In response to the automatic report of the HTTP message including the SOAP message for SC report to the management apparatus 102, when the intermediate apparatus 101 receives the HTTP message including~the SOAP message representing the success of the report of the HTTP message automatically reported, in step S909, the intermediate apparatus 101 generates a SOAP message representing the success of the SC report based on the HTTP message. Also, the intermediate apparatus 101 transmits the generated message to the NRS 305 of the corresponding image forming apparatus 100 (in which the SC occurs).

When the NRS 305 receives from the intermediate apparatus 101 the SOAP message representing the success of the SC report, the NRS 305 reports to the SCS 306 the success of the SC report in step S910.

When the SCS 306 receives from the NRS 305 the report of the success of the SC report, the SCS 306 reports to the OCS 300 a display request for displaying the success of the SC report in step S911.

When the OCS 300 receives from the SCS 306 the display request for displaying the success of the SC report, the OCS 300 displays on the character display unit of the operation panel 205 a message informing of the success of the SC report, as indicated by (E) in FIG. 14, for example, in step S911.

In a case where the engine unit does not become operable upon reboot (restart) of the image forming apparatus 100 by OFF/ON of the main power supply (alternatively, OFF/ON of the software power supply key), i.e., when the engine unit does not return to the normal state, it may not be desirable (in terms of communication resources, for example) that an SC report to the management apparatus 102 is made every time the main power supply is turned OFF/ON. Accordingly, the process as described below may be performed.

After a reboot of the image forming apparatus 100, when an SC of the type A occurs again in the engine unit, in step S912, the SC is detected by the engine CPU by using the sensor, and the occurrence of the SC is reported again to the SCS 306 of the controller board 200.

When the SCS 306 receives the report that the SC occurs again from the engine CPU, the SCS 306 determines the type of SC as a type A. In addition, the SCS 306 reports again the occurrence of the SC to each application in step S913, and also reports it to the NRS 305 in step S914. On this occasion, the serial number information, which is the identification information of the image forming apparatus 100, is added to the report data.

When the NRS 305 receives the report of the occurrence of the SC of type A, in step S915, the NRS 305 determines that the SC report thereof is not required and reports to the SCS 306 that the SC report is not performed.

When the SCS 306 receives the report that the SC report is not performed, in step S916, the SCS 306 reports to the OCS 300 a request for display informing that the SC is being issued.

When the OCS 300 receives from the SCS 306 the request for display informing the user that the SC is being issued, the OCS 300 displays a message informing the user that the SC is being issued, as indicated by (D) in FIG. 14, for example, on the character display unit of the operation panel 205. This screen also displays information of the type of the SC, contact address, and the like.

Further, in response to the automatic report to the management apparatus 102 of the HTTP message including the SOAP message for SC report, when the intermediate apparatus 101 receives the HTTP message including the SOAP message representing the failure of the report of the HTTP message, the intermediate apparatus 101 generates a SOAP message representing the failure of the SC report based on the HTTP message, and transmits the generated message to the NRS 305 of the corresponding image forming apparatus 100.

When the NRS 305 receives from the intermediate apparatus 101 the SOAP message representing the failure of the SC report, the NRS 305 reports to the SCS 306 the failure of the SC report. Alternatively, in response to the transmission of the SOAP message for SC report to the intermediate apparatus 101, when a SOAP message representing the result of the report (success or failure of the SC report) cannot be received from the intermediate apparatus 101 within a predetermined time duration, the NRS 305 also reports to the SCS 306 the failure of the SC report.

When the SCS 306 receives from the NRS 305 the report of the failure of the SC report, the SCS 306 reports to the OCS 300 a request for display of the failure of the SC report.

When the OCS 300 receives from the SCS 306 the request for display of the failure of the SC report, the OCS 300 displays a message informing the user of the failure of the SC report, as indicated by (F) in FIG. 14, for example, on the character display unit of the operation panel 205. This screen also displays information of the type of the SC, the contact address, and the like.

Next, a description will be given of an exemplary embodiment of a process performed in a case where an SC of the type D. (hereinafter referred to as a “type-D SC”) shown in FIG. 12 is issued in the engine unit of the image forming apparatus 100.

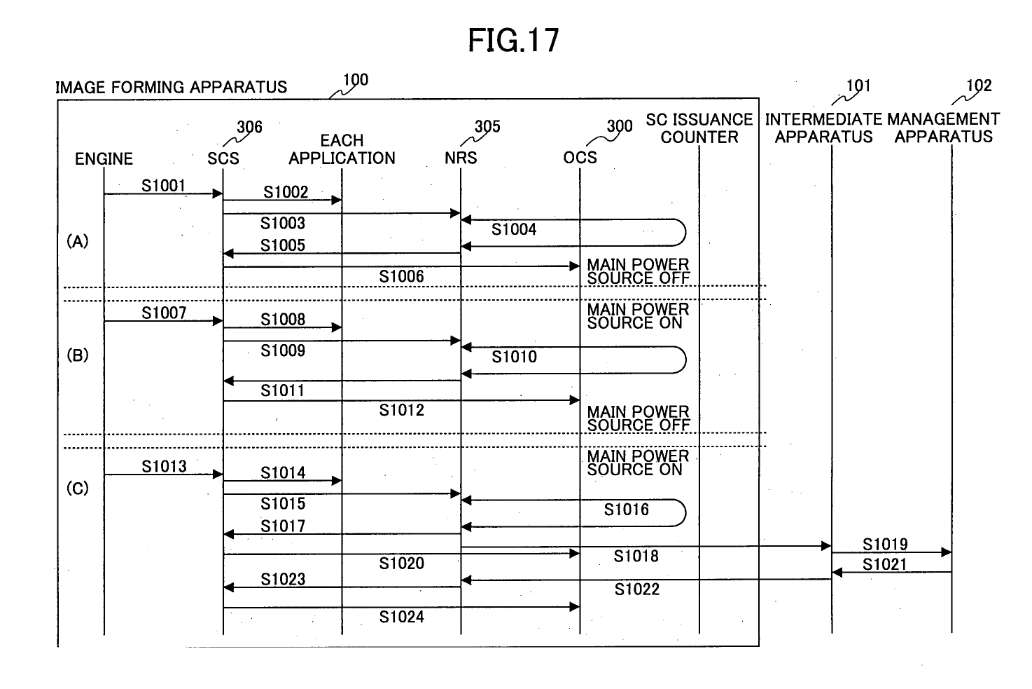

FIG. 17 is a diagram showing examples of a communication sequence in the case where an abnormality of the type D occurs in the engine unit of the image forming apparatus 100.

In the image forming apparatus 100, when a type-D SC is issued in the engine unit, in step S1001, the SC is detected by the engine CPU by using the sensor, and the occurrence of the SC is reported to the SCS 306 of the controller board 200.

When the SCS 306 receives the report of the occurrence of the SC from the engine CPU, the SCS 306 determines the type of the SC based on the reference information shown in FIG. 12. In the exemplary embodiment, the type of SC that is issued this time is determined to be a type D, which can be solved by the user of the corresponding image forming apparatus 100. Thus, the SCS 306 reports the issuance of the SC to each application in step S1002, and thereafter also reports the issuance to the NRS 305 in step S1003. On this occasion, serial number information representing the identification information of the image forming apparatus 100 is added to the report data.

When the NRS 305 receives the report of the issuance of the type-D SC, in step S1004, the NRS 305 reads the count value of a counter (provided in a predetermined storage area of the HDD 201 or NV-RAM 202) of the number of times of issuance of the type-D SCs (hereinafter referred to as a “type-D SC issuance counter”), which is counting means of the number of times of abnormality. In addition, the NRS 305 confirms (determines) the number of times of issuance of the type-D SC.

The type-D SC issuance counter is a counter provided exclusively for the NRS/CSS, which is counted up (+1) every time a type-D SC is issued. Additionally, counters of issuance of SCs of respective types are also provided in addition to the above-mentioned counter. The counters of issuance of SCs of respective types are not associated with control of the NRS/CSS. These counters directly start counting (accumulating) the number of times of issuance of SCs of the respective types immediately after the image forming apparatus 100 is installed (delivered).

Then, the NRS 305 determines whether or not an SC report is required based on the number of times of issuance of the type-D SCs. However, at the first time, the number of times of issuance of the type-D SC (the counted value of the number of times of issuance of the type-D SC) has not reached a predetermined number of times (a predetermined value). Hence, in step S1005, the NRS 305 determines that an SC report is not required and reports to the SCS 306 that the SC report is not performed.

When the SCS 306 receives the report of not performing the SC report, in step S1006, the SCS 306 reports to the OCS 300 a request for a display informing that the SC is being issued.

When the OCS 300 receives from the SCS 306 the request for display informing that the SC is being issued, the OCS 300 displays a message informing that the SC is being issued, as indicated by (D) in FIG. 14, for example, on the character display unit of the operation panel 205.

Then, in a case where the engine unit does not become operable upon reboot of the corresponding image forming apparatus 100 by OFF/ON of the main power supply (OFF/ON of the software power supply key may be performed instead, as will be appreciated), and a type-D SC is issued again, in step S1007, the SC is detected by the engine CPU by using the sensor, and the issuance of the SC is reported again to the SCS 306 of the controller board 200.

Subsequently, in steps S1008 through S1012 (indicated by (B) in FIG. 17), the SCS 306, NRS 305, and OCS 300 perform respective processes similar to those described above (indicated by (A) in FIG. 17). The processes are performed repeatedly until the number of times of issuance of the type-D SC reaches the predetermined number of times (“3”, in this case). When the predetermined number of times is reached, the processes described below are performed.

In a case where a type-D SC is issued again in the engine unit after the reboot of the corresponding image forming apparatus 100 by OFF/ON of the main power supply (OFF/ON of the software power supply key may be performed instead, as will be appreciated), in step S1013, the SC is detected by the engine CPU by using the sensor, and the issuance of the SC is reported to the SCS 306 of the controller board 200.

When the SCS 306 receives from the engine CPU the report that the SC is issued again, in step S1015, the SCS 306 determines the type of the SC to be the type D, which can be solved by the user of the corresponding image forming apparatus 100. Also, the SCS 306 reports the issuance of the SC to each application in step S1014, and also reports it to the NRS 305 in step S1015.

When the NRS 305 receives again the report of the issuance of the type-D SC, in step S1016, the NRS 305 reads the count value of the type-D SC issuance counter to confirm the number of times of issuance of the type-D SC.

Then, the NRS 305 determines whether or not an SC report is required based on the number of times of issuance of type-D SCs. Since the number of times of issuance of type-D SCs reaches “3” this time, the NRS 305 determines that an SC report is required. Accordingly, the NRS reports to the SCS 306 starting of the SC report in step S1017. Also, the NRS 305 generates a SOAP message for SC report (including the serial number added to the report data of the SC), and transmits the generated message to the intermediate apparatus 101 in step S1018.

Subsequently, the SCS 306, NRS 305, OCS 300, intermediate apparatus 101, and management apparatus 102 perform respective processes of steps S1019 through S1024. Since these processes are similar to those in steps S906 through S911, which are described above with reference to FIG. 13, a description thereof will be omitted.

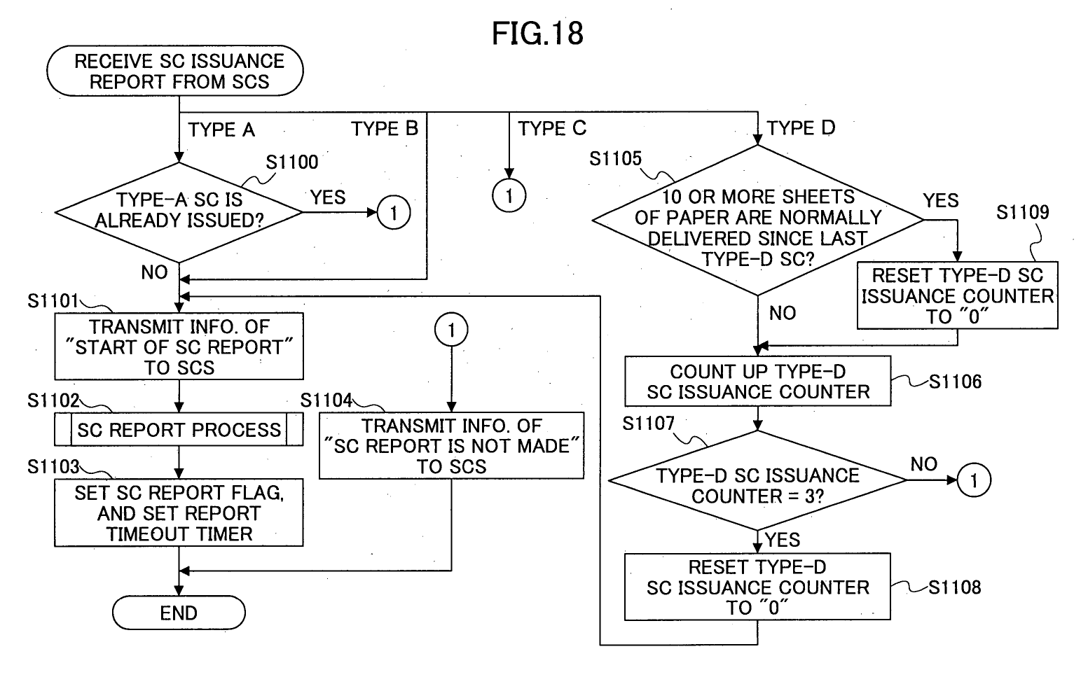

Next, referring to FIG. 18, a description will be given of an exemplary embodiment of the processes performed by the NRS 305.

FIG. 18 is a flow chart showing an example of the processes performed by the NRS 305 at the time of issuance of an SC.

When the NRS 305 receives from the SCS 306 the report of issuance of an SC, the NRS 305 starts a process routine shown in FIG. 18. First, when the SC is of type A, in step S1100, the NRS 305 determines whether or not an SC of the type A is already issued.

Every time an SC is issued, information representing the issuance is stored in the HDD 201 or NV-RAM 202 according to the type of SC. Hence, it is assumed that the SC of the type A is already issued (YES in step S1100) when the type of SC issued the previous time is type A, which is the same as the type of the SC issued this time, and when the accounting counter (counting the number of sheets of paper that are normally delivered and on which an image is already formed) is not counted up (i.e. increased) since the issuance of the SC of the previous time.

When it is determined that the SC of the type A is not issued yet (NO in step S1100), the NRS 305 determines that an SC report is required. Hence, the NRS 305 reports to the SCS 306 starting of the SC report in step S1101, and performs an SC report process in step S1102. In other words, the NRS 305 generates a SOAP message for SC report (including the serial number information added to the report data of the SC), and transmits the generated message to the intermediate apparatus 101.

Next, in step S1103, the NRS 305 sets an SC report in-process flag (hereinafter referred to as an “SC report flag”) representing that an SC report is in operation in the HDD 201 or NV-RAM 202 to “1”. Also, the NRS 305 sets a predetermined time (that is a timeout duration for receiving the report result, for example, 5 minutes) to a report timeout timer, starts timekeeping, and ends the processing.

Then, when the NRS 305 again receives the report of issuance of an SC from the SCS 306, the NRS 305 starts the process routine shown in FIG. 18. When the SC is of the type A, since it is determined that the SC of the type A is already issued, the NRS 305 reports to the SCS 306 that an SC report is not performed, and ends the processing.

The NRS 305 starts the process routine shown in FIG. 18 upon reception of the report of the issuance of the SC from the SCS 306. When the SC is of the type D, in step S1105, the NRS 305 refers to a counter (counting means for counting the number of sheets of paper having images formed thereon) of the number of sheets of paper delivered, so as to determine whether or not a predetermined number or more of sheets of paper on which images are already formed is normally delivered from the plotter engine since the last issuance of the type-D SC. In addition, it is also possible to determine whether or not the number of sheets of paper having images formed by the plotter engine thereon reaches the predetermined number since the last issuance of the type-D SC by referring to a counter that counts the number of sheets of paper on which images are formed.

Then, when the predetermined number (10, in this example) or more of sheets of paper, on which images are already formed is normally delivered from the plotter engine since the last issuance of the type-D SC (when the counted value of the counter of the number of sheets of paper delivered reaches the predetermined value) (YES in step S1105), the type-D SC issuance counter is reset to “0” in step S1109. The reason for performing this process is that, if the predetermined number of sheets of paper are normally delivered, it is possible to consider that the SC is canceled.

Then, the type-D SC issuance counter is counted up (+1) in step S1106, the number of times of issuance of type-D SC is confirmed by reading the count value thereof, and whether or not an SC report is required is determined based on the number of times of issuance of type-D SC. That is, in step S1107, it is determined whether or not the number of times of issuance of type-D SC (the count value of the type-D SC issuance counter) reaches three times, which is the predetermined number of times (the predetermined value) in the exemplary embodiment. Then, if the number of times of issuance of type-D SC has not reached three (NO in step S1107), it is determined that the SC report is not required, and the process proceeds to step S1104. It will be appreciated, of course, that the predetermined number of times is not limited to three times. Also, the process of step S1106 is also performed when the decision result in step S1105 is NO.

When the number of times of issuance of type-D SC reaches three times (YES in step S1107), the counter of the issuance of type-D SC is reset to “0” in step S1108. Then, the process proceeds to step S1101.

The process routine shown in FIG. 18 is initiated upon reception of the report of the issuance of an SC from the SCS 306. When the SC is of the type B, the process proceeds to step S1101. When the SC is of the type C, the process proceeds to step S1104.

Next, a description will be given of another exemplary embodiment of a process in a case where a type-D SC, which is shown in FIG. 12, is issued in the engine unit of the image forming apparatus 100.

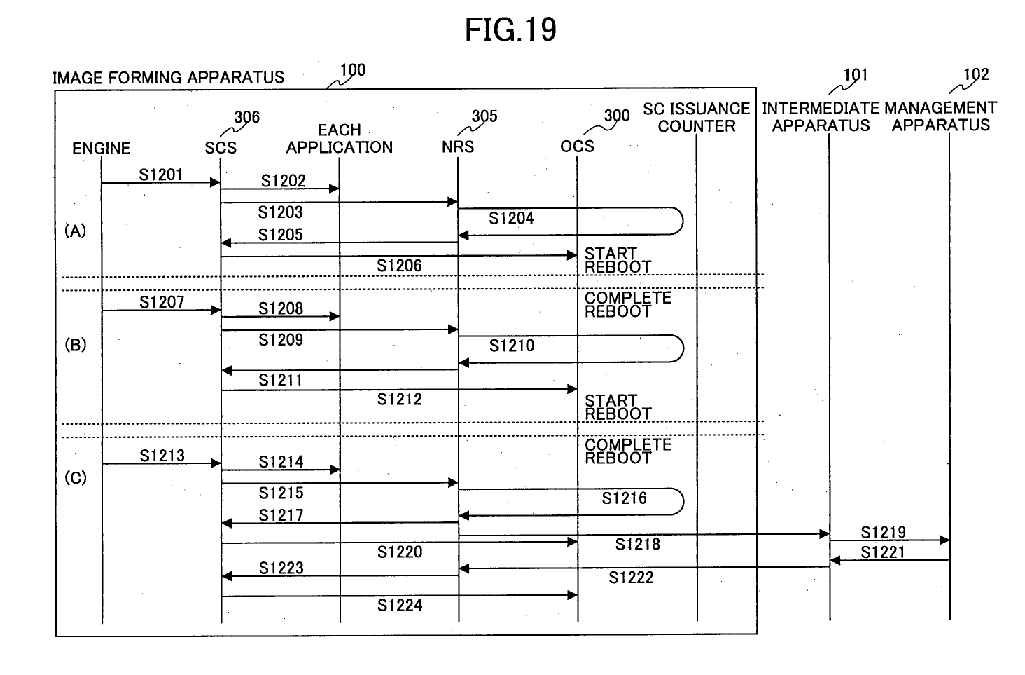

FIG. 19 is a diagram showing another example of the communication sequence in the case where a type-D SC is issued in the engine unit of the image forming apparatus 100.

In the image forming apparatus 100, when a type-D SC is issued, in step S1201, the SC is detected by the engine CPU by using the sensor, and the issuance of the SC is reported to the SCS 306 of the controller board 200.

The SCS. 306 receives from the engine CPU the report of issuance of the SC. When the SCS 306 determines that the SC is of the type D, which can be solved by the user of the corresponding image forming apparatus 100, the SCS 306 reports to each application the issuance of the SC in step S1202, and also reports it to the NRS 305 in step S1203.

When the NRS 305 receives the report of the issuance of the type-D SC, in step S1204, the NRS 305 reads the count value of the type-D SC issuance counter to confirm the number of times of issuance of the type-D SC. The NRS 305 then determines whether or not an SC report is required based on the number of times of issuance of the type-D SC. Since the number of times of issuance of the type-D SC has not reached the predetermined number of times as this is the first time, the NRS 305 determines that the SC report is not required, and reports to the SCS 306 that the SC of the image forming apparatus 100 (equipment) is reset (equipment reboot) in step S1205.

When the SCS 306 receives the report of reset of the SC of the image forming apparatus 100, the SCS 306 reports a display request for displaying the SC reset to the OCS 300 in step S1206. Then, the corresponding image forming apparatus 100 is rebooted (restarted) when the reboot key is pressed down or when a predetermined time has elapsed (timed out) before the reboot key is pressed down.

When the OCS 300 receives from the SCS 306 the display request for displaying the SC reset of the corresponding image forming apparatus 100, the OCS 300 displays on the character display unit of the operation panel 205 a message informing the user of the image forming apparatus 100 the reset of the SC of the image forming apparatus 100, as indicated by (C) in FIG. 14, for example. In the exemplary embodiment, progress of the SC reset (reboot) is displayed at the bottom of the display screen image.

In a case where the corresponding image forming apparatus 100 is rebooted but the engine unit does not become operative, and a type-D SC is issued again, the SC is detected by the engine CPU by using the sensor, and the issuance of the SC is reported to the SCS 306 of the controller board 200 in step S1207.

Then, in steps S1208 through 1212, the SCS 306, NRS 305, and OCS 300 perform respective processes similar to those described above. If the type-D SC is not solved, the processes are performed repeatedly until the number of times of issuance of type-D SC reaches the predetermined number of times (“3”, in this case). When the predetermined number of times is reached, the engine CPU reports that a type-D SC is issued again in the engine unit by reboot of the image forming apparatus 100 in step S1213, and the processes of steps S1214 through S1224 are performed. Since these processes are almost identical to the processes of steps S1014 through S1024, which are explained above with reference to FIG. 17, the description thereof will be omitted.

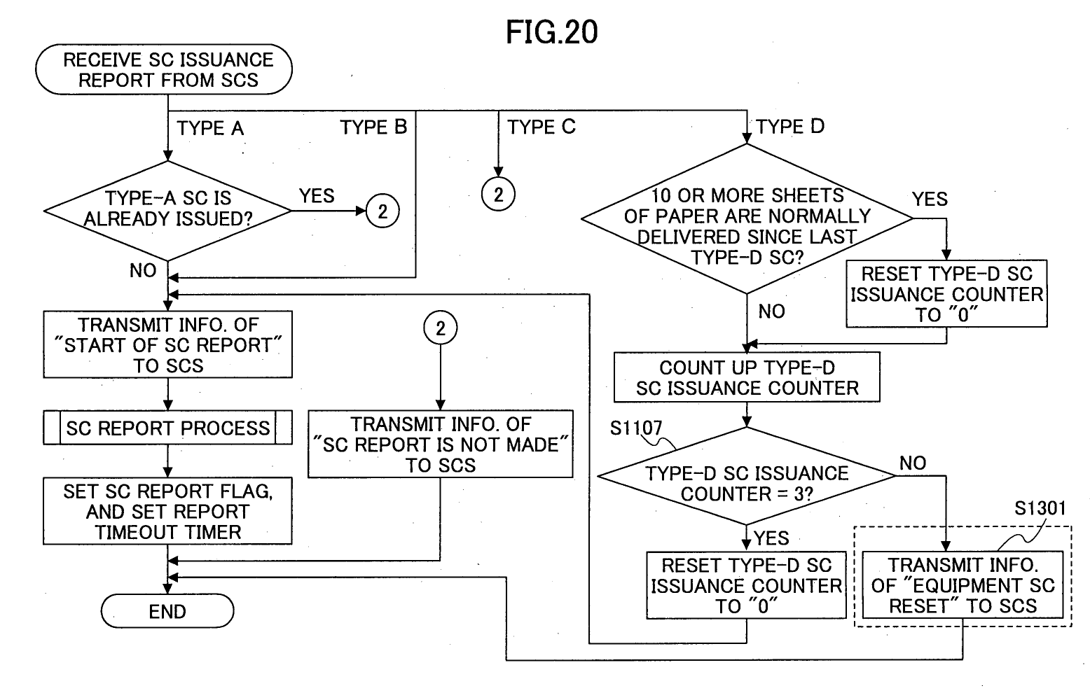

Next, referring to FIG. 20, a description will be given of another exemplary embodiment of processes of the NRS 305. Since the processes are almost identical to those shown in FIG. 18, only the different processes will be explained.

FIG. 20 is a flow chart showing another example of the processes performed by the NRS 305 when an SC is issued.

When the number of times of issuance of the type-D SC (the count value of the type-D SC issuance counter) has not reached 3 times (NO in step S1107), which is the predetermined number of times, the NRS 305 determines that an SC report is not required and proceeds to the process of step S1301, which is surrounded and indicated by a dashed line.

In step S1301, the NRS 305 reports to the SCS 306 that the SC of the corresponding image forming apparatus 100 is reset (equipment SC reset).

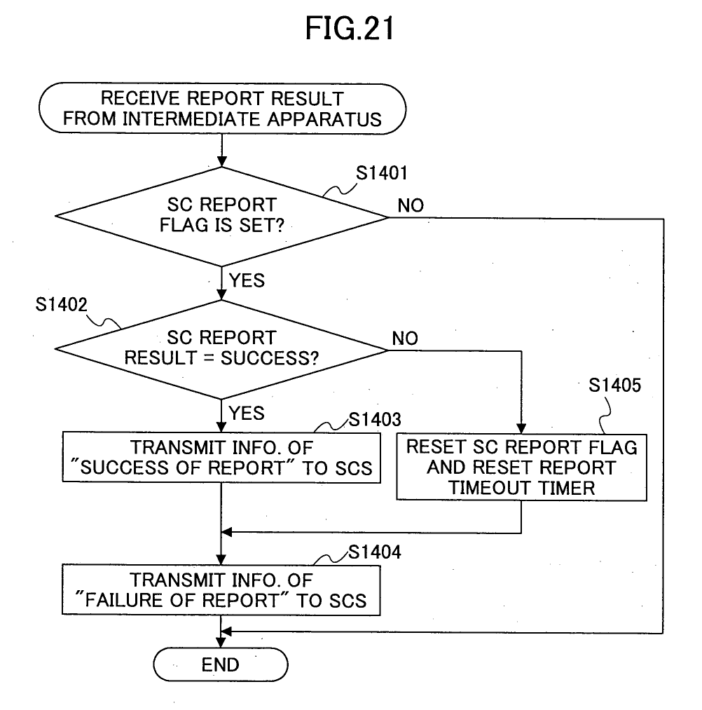

Next, referring to FIG. 21, a description will be given of an exemplary embodiment of an SC report result reception process performed by the NRS 305.

FIG. 21 is a flow chart showing an example of the SC report result reception process performed by the NRS 305.

When the NRS 305 receives a SOAP message representing an SC report result (success or failure of the SC report) from the intermediate apparatus 101 in response to the SOAP message for SC report to the intermediate apparatus 101, in step S1401, the NRS 305 checks the SC report flag of the HDD 201 or NV-RAM 202. When the SC report flag is reset to “0” (NO in step S1401), the process ends.

When the SC report flag is set to 11111 (YES in step S1401), it is determined whether the SC report succeeds or fails from the received SOAP message representing the SC report result in step S1402. When the SC report succeeds (when a SOAP message representing the success of the SC report is received)(YES in step S1402), the success of the SC report is reported to the SCS 306 in step S1403. When the SC report fails (when a SOAP message representing the failure of the SC report is received) (NO in step S1402), the failure of the SC report is reported to the SCS 306 in step S1405. Then, in step S1404, each of the SC report flag and the report timeout timer is reset to “0”, and the process ends.

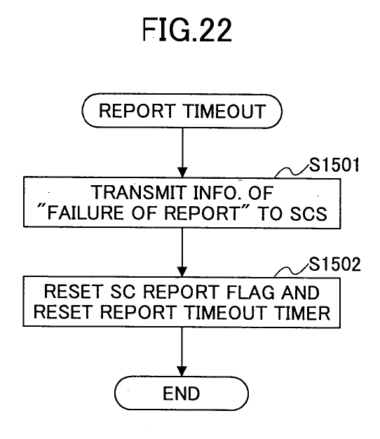

Next, referring to FIG. 22, a description will be given of an exemplary embodiment of a report timeout process performed by the NRS 305.

FIG. 22 is a flow chart showing an example of the report timeout process performed by the NRS 305.

When a time measured by the report timeout timer reaches a predetermined time (at time out), the NRS 305 starts the process routine shown in FIG. 22 by a signal that is output from the report timeout timer. The NRS 305 determines that the SC report fails on the ground that the SOAP message, representing the SC report result, cannot be received from the intermediate apparatus 101 in response to the SOAP message for SC report to the intermediate apparatus 101. Also, the NRS 305 reports the failure of the SC report to the SCS 306 in step S1501. Then, in step S1502, the NRS 305 resets each of the SC report flag and the report timeout timer of the HDD 201 or NV-RAM 202 to “0”, and the process ends.

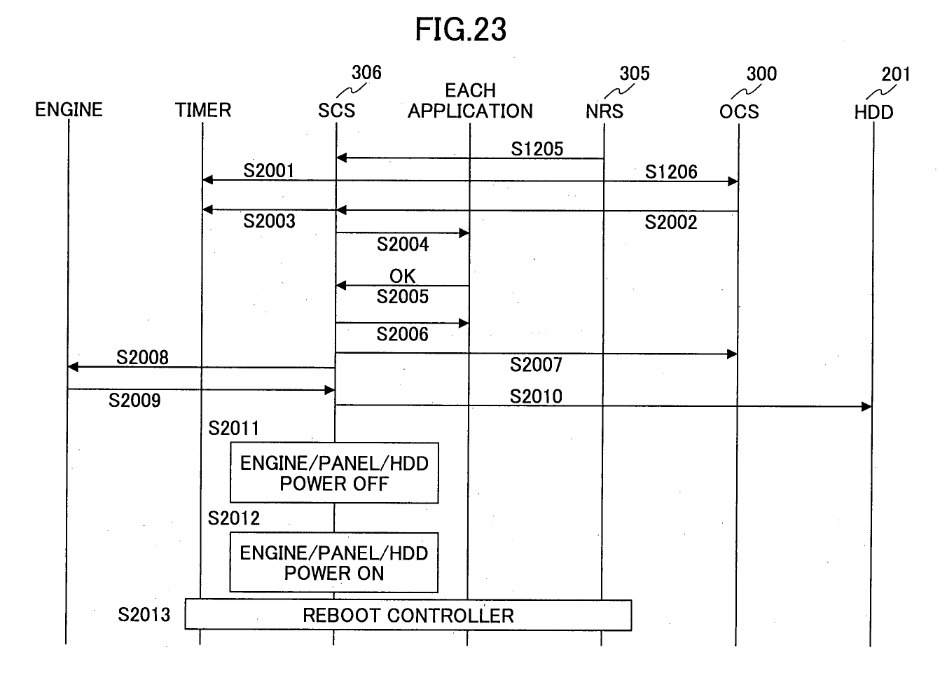

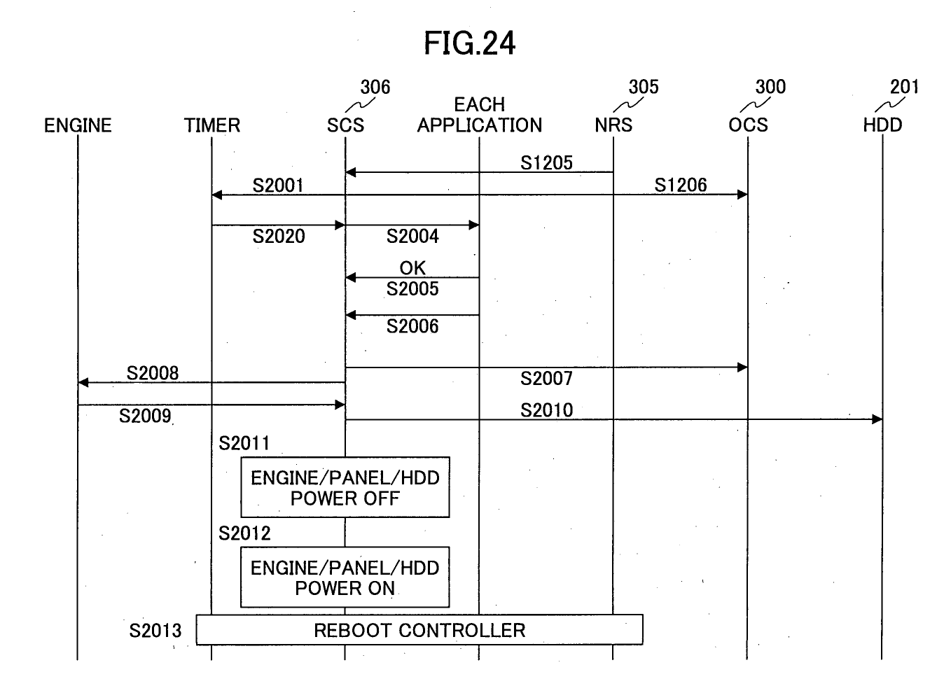

Next, referring to FIGS. 23 and 24, a description will be given of an exemplary embodiment of processes in the case where, in the communication sequence shown in FIG. 19, the SCS 306 receives from the NRS 305 a report that the SC of the corresponding image forming apparatus 100 is reset.

FIGS. 23 and 24 are diagrams showing different examples of the communication sequence in the case where the SCS 306 receives the report that the SC of the image forming apparatus 100 is reset.

As explained with reference to FIG. 19, when the SCS 306 receives the report that the SC of the corresponding image forming apparatus 100 is reset, in step S1206, the SCS 306 reports to the OCS 300 a display request for displaying the reset of the SC.

In addition, in step S2001, the SCS 306 sets a predetermined time (a timeout time for starting reboot by the reboot key) to a reboot start timer.

When the OCS 300 receives from the SCS 306 the display request for displaying the reset of the, SC of the image forming apparatus 100, a message informing the user of the reset of the SC of the image forming apparatus 100, as indicated by (C) in FIG. 14, is displayed on the character display unit of the operation panel 205. Then, when the user who sees the display screen image presses down the reboot key on the operation panel 205, in step S2002, it is reported to the SCS 306 that the reboot key is pressed down (refer to FIG. 23).

When the SCS 306 receives the report that the reboot key is pressed down from the OCS 300 before a time measured by the reboot start timer reaches the timeout time for starting reboot, the SCS 306 cancels the reboot start timer (resets the reboot start timer to “0”) in step S2003. Thereafter, in step S2004, the SCS 306 performs a query of application off-line, which is an instruction to stop operation, on each application. When the SCS 306 receives from each application a response (OK) of application off-line in step S2005, the SCS 306 informs (delivers) each application of determination of application off-line in step S2006. Then, in step S2007, the SCS 306 informs the OCS 300 of stopping communication with the operation panel 205.

Subsequently, in step S2008, the SCS 306 posts an engine-reset request to the engine unit. After receiving the response to the engine-reset request in step S2009, the SCS 306 informs the HDD 201 that access is stopped in step S2010. Then, in step S2011, feeding to the engine unit, the operation panel 205, and the HDD 201 is stopped (power is turned OFF). Thereafter, in step S2012, the stoppage of feeding is canceled (power is turned ON). Further, in step S2013, the controller board 200 is also rebooted.

On the other hand, in a case where the time measured by the reboot start timer reaches the timeout time (times out) for starting reboot before the SCS 306 receives, from the OCS 300, a notification that the reboot key is pressed down, as shown in FIG. 24, the SCS 306 receives a timeout notification from the reboot start timer in step S2020. Thus, in step S2004, the SCS 306 performs a query of application off-line, which is an instruction to stop operation, to each application at the time. Thereafter, processes similar to those described above are performed.

In addition, if an issued (determined) SC is of the type B shown in FIG. 12 and the SC is an SC of a predetermined function, then when the predetermined function where the SC is detected is selected by a key operation on the operation panel 205 (when a request for using the function where abnormality is detected is received from the operation panel 205), a message informing of the issuance of the SC is displayed on the character display unit of the operation panel 205. Further, when an issued SC is of the type C, the history of the SC is written to the HDD 201 or NV-RAM 202.

According to the above-mentioned embodiments, it is possible to obtain the following operation advantages (1) through (11).

(1) The controller CPU of the image forming apparatus 100 determines the type of issued SC, and reports to the management apparatus 102 the issued SC (informs the management apparatus 102 of the issued SC) when the SC is of the type A, which cannot be solved by the user of the image forming apparatus 100. Hence, it is possible to reduce communication costs at the time of issuance of an SC in the image forming apparatus 100.

(2) The controller CPU of the image forming apparatus 100 receives the report result from the management apparatus 102 with respect to an SC report to the management apparatus 102. Thus, it is not necessary to report the SC to the management apparatus 102 every time an SC of type A is issued. Accordingly, it is possible to further reduce communication costs at the time of issuance of an SC in the image forming apparatus 100.

(3) The controller CPU of the image forming apparatus 100 sets the timeout time for receiving the report result with respect to the SC report to the management apparatus 102. In addition, when the report result cannot be received from the management apparatus 102 within the timeout time, a message informing the failure of the SC report is displayed on the character display unit of the operation panel 205. Hence, the need for indefinitely waiting for the response (reception of the report result) is eliminated. Accordingly, processing efficiency is improved.

(4) If the determined type of SC is type B, which represents an abnormality in a predetermined function, and when a request for using the predetermined function is received from the operation panel 205, the controller CPU of the image forming apparatus 100 displays a message informing of the issuance of the SC on the character display unit of the operation panel 205. Accordingly, the user can normally use functions where an SC is not detected.

(5) When the determined type of SC is type C (for example, communication malfunction), which requires only history saving, the history of the SC is written to the HDD 201 or NV-RAM 202. Thus, it is possible for the user to operate the operation panel 205 to display the history of SCs on the character display unit.

(6) When the determined type of SC is of type D, which can be solved by the user of the image forming apparatus 100, the controller CPU of the image forming apparatus 100 causes the type-D SC issuance counter to count up (i.e. increase). When the count value of the type-D SC issuance counter reaches a predetermined value, the issued SC is reported to the management apparatus 102. Hence, it is possible to further reduce communication costs at the time of issuance of an SC in the image forming apparatus 100.

(7) When the count value of the type-D SC issuance counter has not reached the predetermined value, the controller CPU of the image forming apparatus 100 displays a message informing the user that the SC is being issued on the character display unit of the operation panel 205. Thus, it becomes possible to solve the SC by the user through an OFF/ON operation of the main power source or an operation of the software power source key or reboot key. Accordingly, it is possible to improve the availability factor of the image forming apparatus 100.

(8) When the count value of the type-D SC issuance counter reaches a predetermined value, the controller CPU of the image forming apparatus 100 resets the count value. Hence, it is possible to know that an SC report to the management apparatus 102 is accurately performed, and to prepare for the next issuance of an SC.

(9) The controller CPU of the image forming apparatus 100 causes the accounting counter to count the number of sheets of paper each having an image formed thereon (the number of sheets of paper normally delivered) until a type-D SC is detected again since a type-D SC is detected. Also, when the count value of the type-D SC issuance counter reaches a predetermined value, the controller CPU resets the count value. Thus, it is assumed that normal function is performed. Accordingly, it is possible to further reduce communication costs.

(10) When the count value of the type-D SC issuance counter has not reached a predetermined value, the controller CPU of the image forming apparatus 100 causes the image forming apparatus 100 to automatically reboot (restart). Hence, it becomes possible to solve an SC even if an OFF/ON operation of the main power source or an operation of the software power source key or reboot key is not performed by the user. Accordingly, it is possible to further improve the availability factor of the image forming apparatus 100.

(11) Before causing the image forming apparatus 100 to automatically reboot (reset), the controller CPU of the image forming apparatus 100 displays a message informing the user of the image forming apparatus 100 a reset of an SC of the image forming apparatus 100 on the character display unit of the operation panel 205. In this manner, it is possible to avoid reboot while the image forming apparatus 100 is in use.

Further, as an example of an electronic apparatus, the explanation is given of the image forming apparatus 110 with communication functions (intermediate functions) and the image forming apparatus 100 connected to the intermediate apparatus 101 that carry out communication functions. However, these are not limitations of the present invention. The present invention may be applied to any suitable electronic apparatuses having communication functions, including computers and the like connectable to a network, and network-connected home appliances, automatic vending machines, medical equipment, power supply equipment, air conditioning systems, measuring systems of gas, water, electricity etc., and the like that have communication functions or are connected with an intermediate apparatus carrying out communication functions. Additionally, when these apparatuses are used as managed apparatuses, it is also possible to operate the remote management system in a manner similar to that described above. Further, regarding the remote management system of the electronic apparatuses, the above-mentioned embodiment is not a limitation on the configurations of the electronic apparatuses, remote management intermediate apparatuses, and management apparatus, or on the connection type among them.

In addition, the program according to the present invention is a program for causing a computer that controls communication apparatuses, such as the above-mentioned image forming apparatuses having communication means for communicating with external apparatuses, to achieve each function according to the present invention. In other words, the program according to the present invention causes such computer to function as the following means: the abnormality detection means, abnormality notification means, abnormality type determination means, use request reception means, abnormality display means, abnormality history writing means, abnormality counting means, abnormality counting control means, reset means, and counting means for counting the number of sheets of paper each having an image formed thereon. The above-mentioned effects can be obtained by causing a computer to carry out such program.

Such program may be stored in advance in storage means provided in a computer, such as a ROM, a HDD, or the like. However, the program may also be provided by being recorded on a recording medium, such as an optical disk (for example, CD-ROM, CD-R, DVD-R, DVD-ROM, and DVD-RW), a magneto optical disk (for example, an MO), and a flexible disk. Also, the program may be provided by being recorded on a non-volatile recording medium (memory), such as an SRAM, an EEPROM, a memory card. Each of the above-mentioned procedures can be performed by installing the program that is recorded on such a medium (memory) into a computer to cause the CPU thereof to carry out the program, or by causing the CPU to read the program from the memory and carry out the program. FIG. 7 shows an example in which the card memory 35 stores the program for realizing each function according to the present invention.

Further, it is also possible to carry out the program by downloading the program from external equipment provided with a recording medium recording the program or from external equipment storing the program in storage means, each of the external equipment being connected to a network.

As mentioned above, according to the present invention, it is possible to reduce communication costs at the time when an abnormality occurs in an electronic apparatus such as an image forming apparatus. In addition, it is also possible to improve the availability factor.

The present invention is not limited to the specifically disclosed embodiments, and variations and modifications may be made without departing from the scope of the present invention.

The present application is based on Japanese priority applications No. 2002-276524 filed on Sep. 24, 2002 and No. 2003-193878 filed on Jul. 8, 2003, the entire contents of which are hereby incorporated by reference.

What is claimed is:

1. An electronic apparatus, comprising:
an abnormality detector detecting an abnormality when the abnormality occurs;
an abnormality type determination part determining a type of the abnormality detected by said abnormality detector; and
an abnormality notification part for informing an external apparatus of the abnormality when the type of the abnormality determined by said abnormality type determination part represents an abnormality that cannot be eliminated by a user of said electronic apparatus.

2. The electronic apparatus as claimed in claim 1, further comprising:
a use request reception part receiving a request for using one or more functions; and
an abnormality display part that, in a case where the type of abnormality determined by the abnormality type determination part represents an abnormality in a predetermined function, displays that the abnormality is occurring only when a request for using the predetermined function is received by the use request reception part.

3. The electronic apparatus as claimed in claim 1, further comprising:
a non-volatile storage part; and
an abnormality history writing part for writing history of the abnormality to said non-volatile storage part when the type of the abnormality determined by the abnormality type determination part represents an abnormality that requires only history saving.

4. The electronic apparatus as claimed in claim 1, further comprising:
an abnormality counter for counting the number of times of occurrence of an abnormality; and
an abnormality counter controller for causing said abnormality counter to up count when the type of the abnormality determined by the abnormality type determination part represents an abnormality that can be eliminated by the user of the electronic apparatus,
wherein the abnormality notification part includes means for informing the external apparatus of a corresponding abnormality when a count value of the abnormality counter reaches a predetermined value.

5. The electronic apparatus as claimed in claim 4, further comprising:
means for displaying occurrence of an abnormality when the count value of the abnormality counter has not reached the predetermined value.

6. The electronic apparatus as claimed in claim 4, further comprising:
a reset part resetting the count value of the abnormality counter when the count value thereof reaches the predetermined value.

7. The electronic apparatus as claimed in claim 4, further comprising:
an image forming part forming an image on a recording medium;
a sheet counter counting the number of sheets each having an image thereon formed by said image forming part since the abnormality that can be eliminated by the user of the electronic apparatus is detected by the abnormality detector until the abnormality is detected again; and
a reset part for resetting the count value of the abnormality counter when a count value of said sheet counter reaches the predetermined value.

8. The electronic apparatus as claimed in claim 4, further comprising:
means for causing the electronic apparatus to reboot when the count value of the abnormality counter has not reached the predetermined value.

9. The electronic apparatus as claimed in claim 8, further comprising:
means for displaying that reboot is to be performed before the electronic apparatus is caused to perform reboot.

10. A remote management system remotely managing a plurality of electronic apparatuses by a management apparatus via a communication line, comprising:
the plurality of electronic apparatuses; and
the management apparatus,
wherein each of the electronic apparatuses includes:
an abnormality detector detecting an abnormality when the abnormality occurs in the electronic apparatuses;
an abnormality type determination part determining a type of the abnormality detected by said abnormality detector; and
an abnormality notification part for informing the management apparatus of the abnormality, together with identification information of one or more of the electronic apparatuses in which the abnormality occurs, when the type of the abnormality determined by said abnormality type determination part represents an abnormality that cannot be eliminated by a user of said one or more of the electronic apparatuses.

11. The remote management system as claimed in claim 10, wherein each of the electronic apparatuses further includes:
an abnormality counter counting the number of times of occurrence of an abnormality; and
an abnormality counter controller for causing said abnormality counter to up count when the type of the abnormality determined by the abnormality type determination part represents an abnormality that can be eliminated by the user of the electronic apparatus, and
wherein the abnormality notification part of each of the electronic apparatuses includes means for informing the management apparatus of a corresponding abnormality together with identification information of the electronic apparatus in which the abnormality occurs, when a count value of said abnormality counter reaches a predetermined value.

12. The remote management system as claimed in claim 11, wherein each of the electronic apparatuses further includes means for displaying that an abnormality is occurring when the count value of the abnormality counter has not reached the predetermined value.

13. The remote management system as claimed in claim 11, wherein each of the electronic apparatuses further includes a reset part for resetting the count value of the abnormality counter when the count value thereof reaches the predetermined value.

14. The remote management system as claimed in claim 11, wherein each of the electronic apparatuses further includes:
an image forming part forming an image on a recording medium;
a sheet counter for counting the number of sheets each having an image thereon formed by said image forming part since the abnormality that can be eliminated by the user of the electronic apparatus is detected by the abnormality detector until the abnormality is detected again; and
a reset part resetting the count-value of the abnormality counter when a count value of said sheet counter reaches a predetermined value.

15. The remote management system as claimed in claim 11, wherein each of the electronic apparatuses further includes:
means for causing the electronic apparatus to reboot when the count value of the abnormality counter has not reached the predetermined value.

16. The remote management system as claimed in claim 15, wherein each of the electronic apparatuses further includes:
means for displaying that reboot is to be performed before the electronic apparatus is caused to perform reboot.

17. A method of controlling an electronic apparatus, said method comprising the steps of:
detecting an abnormality when the abnormality occurs in the electronic apparatus;
determining a type of the detected abnormality; and
informing an external apparatus of the abnormality when the determined type of the abnormality represents an abnormality that can not be eliminated by a user of the electronic apparatus.

18. The method as claimed in claim 17, further comprising the step of:
displaying, in a case where the determined type of the abnormality represents an abnormality in a predetermined function, that the abnormality is occurring, only when a request for using the predetermined function is received.

19. The method as claimed in claim 17, further comprising the step of:
saving history of the abnormality when the determined type of the abnormality represents an abnormality that requires only history saving.

20. The method as claimed in claim 17, further comprising the steps of:
up counting a count value when the determined type of the abnormality represents an abnormality that can be eliminated by the user of the electronic apparatus; and
informing the external apparatus of a corresponding abnormality when the count value reaches a predetermined value.

21. The method as claimed in claim 20, further comprising the step of:
displaying that an abnormality is occurring when the count value has not reached the predetermined value.

22. The method as claimed in claim 20, further comprising the step of:
resetting the count value when the count value thereof reaches the predetermined value.

23. The method as claimed in claim 20, further comprising the step of:
causing the electronic apparatus to reboot when the count value has not reached the predetermined value.

24. The method as claimed in claim 23, further comprising the step of:
displaying that reboot is to be performed before the electronic apparatus is caused to perform reboot.

25. A program for causing a computer to control an electronic apparatus, said program comprising the instructions of:
causing the computer to detect an abnormality when the abnormality occurs in the electronic apparatus;
causing the computer to determine a type of the detected abnormality; and
causing the computer to inform an external apparatus of the abnormality when the type of the abnormality is determined to represent an abnormality that cannot be eliminated by a user of the electronic apparatus.

26. The program as claimed in claim 25, further comprising the instructions of:
causing the computer to receive a request for using one or more functions of the electronic apparatus; and
causing the computer to display that the abnormality is occurring, in a case where the type of abnormality is determined to represent an abnormality in a predetermined function, and only when a request for using the predetermined function is received.

27. The program as claimed in claim 25, further comprising the instruction of:
causing the computer to save history of the abnormality when the type of the abnormality is determined to represent an abnormality that requires only history saving.

28. The program as claimed in claim 25, further comprising the instructions of:
causing the computer to count the number of times of occurrence of an abnormality in the electronic apparatus;
causing the computer to up count when the type of the abnormality is determined to represent an abnormality that can be eliminated by the user of the electronic apparatus; and
causing the computer to inform the external apparatus of a corresponding abnormality when a count value reaches a predetermined value.

29. The program as claimed in claim 28, further comprising the instruction of:
causing the computer to display occurrence of an abnormality when the count value has not reached the predetermined value.

30. The program as claimed in claim 28, further comprising the instruction of:
causing the computer to reset the count value when the count value thereof reaches the predetermined value.

31. The program as claimed in claim 28, further comprising the instructions of:
causing the computer to form an image on a recording medium;
causing the computer to count the number of sheets each having an formed image thereon since the abnormality that can be eliminated by the user of the electronic apparatus is detected until the abnormality is detected again; and
causing the computer to reset the count value when a count value of the number of sheets reaches a predetermined value.

32. The program as claimed in claim 28, further comprising the instruction of:
causing the computer to cause the electronic apparatus to reboot when the count value of the number of times of occurrence of an abnormality has not reached the predetermined value.

33. The program as claimed in claim 32, further comprising the instruction of:
causing the computer to display that reboot is to be performed before the electronic apparatus is caused to perform reboot.

34. A processor-readable medium storing a program for causing a computer to control an electronic apparatus, said program comprising the instructions of:
causing the computer to detect an abnormality when the abnormality occurs in the electronic apparatus;
causing the computer to determine a type of the detected abnormality; and
causing the computer to inform an external apparatus of the abnormality when the type of the abnormality is determined to represent an abnormality that cannot be eliminated by a user of the electronic apparatus.

35. The processor-readable medium storing the program as claimed in claim 34, wherein the program further comprises the instructions of:
causing the computer to receive a request for using one or more functions of the electronic apparatus; and
causing the computer to display that the abnormality is occurring, in a case where the type of abnormality is determined to represent an abnormality in a predetermined function, and only when a request for using the predetermined function is received.

36. The processor-readable medium storing the program as claimed in claim 34, wherein the program further comprises the instruction of:
causing the computer to save history of the abnormality when the type of the abnormality is determined to represent an abnormality that requires only history saving.

37. The processor-readable medium storing the program as claimed in claim 34, wherein the program further comprises the instructions of:
causing the computer to count the number of times of occurrence of an abnormality;
causing the computer to up count when the type of the abnormality is determined to represent an abnormality that can be eliminated by the user of the electronic apparatus; and
causing the computer to inform the external apparatus of a corresponding abnormality when a count value reaches a predetermined value.

38. The processor-readable medium storing the program as claimed in claim 37, wherein the program further comprises the instruction of:
causing the computer to display occurrence of an abnormality when the count value has not reached the predetermined value.

39. The processor-readable medium storing the program as claimed in claim 37, the program further comprises the instruction of:
causing the computer to reset the count value when the count value thereof reaches the predetermined value.

40. The processor-readable medium storing the program as claimed in claim 37, wherein the program further comprises the instructions of:
causing the computer to form an image on a recording medium;
causing the computer to count the number of sheets each having an formed image thereon since the abnormality that can be eliminated by the user of the electronic apparatus is detected until the abnormality is detected again; and
causing the computer to reset the count value when a count value of the number of sheets reaches a predetermined value.

41. The processor-readable medium storing the program as claimed in claim 37, wherein the program further comprises the instruction of:
causing the computer to cause the electronic apparatus to reboot when the count value of the number of times of occurrence of an abnormality has not reached the predetermined value.

42. The processor-readable medium storing the program as claimed in claim 41, wherein the program further comprises the instruction of:
causing the computer to display that reboot is to be performed before the electronic apparatus is caused to perform reboot.
